(19) United States
(12) Patent Application Publication
(10) Pub. No.: US 2023/0267855 A1
(43) Pub. Date: Aug. 24, 2023

(54) EDUCATIONAL CELESTIAL GLOBE

(71) Applicant: SONGAM SPACE CENTER, Gyeonggi-do (KR)

(72) Inventor: Hyun Sang Kim, Gyeonggi-do (KR)

(21) Appl. No.: 18/017,609

(22) PCT Filed: Jul. 26, 2021
(86) PCT No.: PCT/KR2021/009616

§ 371 Date: Jan. 23, 2023

(30) Foreign Application Priority Data
Jul. 24, 2020 (KR) 10-2020-0092449

(51) Int. Cl. G09B 27/06

(52) U.S. Cl. CPC G09B 27/06

(57) ABSTRACT

A celestial globe according to the present invention is characterized by comprising: a celestial sphere part for displaying constellations; a horizontal coordinate system part which is accommodated inside the celestial sphere part, and includes a disk part defining the surface of the ground at an observation spot and an upper hemisphere portion coupled to the upper side of the disk part and defining the sky as viewed from the perspective of an observer, and a rotation shaft member which defines the rotation axis of the Earth, wherein one side of the rotation shaft member is rotatably coupled to the disk part and the other side passes through the celestial sphere part.

### TECHNICAL FIELD

The present disclosure relates to a celestial globe for education.

### BACKGROUND ART

The present disclosure relates to a celestial globe for education, and more specifically, to a celestial globe for education in which horizontal coordinates and equatorial coordinates may be easily known, and an observer may simulate motion of a celestial body outside the celestial globe while imagining that they are standing inside the celestial globe.

Such a celestial globe has been made since the ancient Greek era, and is known to be made by Thales (BC 624 to BC 546) of Miletus, an ancient city in Greece, for the first time around the 6th century B.C. The oldest celestial globe is the Farnese celestial globe, housed in the National Archaeological Museum of Naples, Greece, and is estimated to be made in the 3rd century B.C.

A celestial globe is a celestial sphere model in which the location of stars, constellation, the ecliptic, and great circles such as the celestial globe equator are displayed on the surface of a sphere outside the celestial globe while imagining that an observer is standing inside the celestial globe. Like a globe representing the distribution of water and land on the surface of the earth, topography, longitude, latitude, etc., the celestial globe is a device made by viewing the space surrounding the earth as a sphere, and drawing stars, constellation, and celestial globe equator, ecliptic, hour circle, declination line, etc. to know all phenomena of the actual celestial sphere, that is, the appearance, altitude, and direction of celestial bodies.

In the celestial globe, the situation of the celestial globe as seen from inside the celestial sphere is drawn on the sphere, so the observer sees it from outside the celestial globe. Therefore, the constellations are actually turned upside down, unlike what they see inside the celestial globe.

Using a celestial globe, the position of a celestial body on the celestial sphere may be measured through various coordinate systems. Examples of a widely used coordinate system among the coordinate systems used to indicate the position of a celestial body include a horizontal coordinate system, which is a coordinate system that indicates the position of a celestial body in terms of azimuth and altitude based on the horizon where the observer is standing centered on the observer and the north point on the horizon, and an equatorial coordinate system, which is a coordinate system that indicates the position of a celestial body in right ascension and declination using the celestial globe equator and vernal equinox point centered on the earth.

In general, in the case of conducting classes on motion of the earth during the curriculum of elementary and middle schools, lectures are conducted using teaching aids such as the celestial globe, globe, and orbit tellurium as above. Nevertheless, it is very difficult for students to understand various coordinate system concepts and spatial and three-dimensional concepts. Therefore, in order to increase learning efficiency, a teaching aid (registered Patent No. 10-1597031, celestial globe for education) that has improved the existing celestial globe has been proposed.

A conventional celestial globe for education includes a celestial globe engraved with star positions, constellation, and the ecliptic, a horizontal coordinate system accommodated inside the celestial globe, a rotation shaft defining the earth’s rotation axis through the celestial globe and the horizontal coordinate system part, and a support for supporting the rotation shaft.

However, in the conventional celestial globe for education, a hemisphere representing the horizontal coordinate system and a disk are installed inside the celestial sphere representing the equatorial coordinate system to simultaneously explain the horizontal coordinate system and the equatorial coordinate system. However, in order to change the latitude of an observation point, if the position of the rotation shaft relative to the hemisphere is changed, the disk that shall be horizontal with the ground is inclined, so the celestial body at the observation point that the observer wants to observe is also inclined. In the process of interpreting the supernal sphere of the observation point, since a user has to consider the inclined horizon, there may be a problem of misinterpreting the supernal sphere of the observation point.

In addition, in the process of rotating the celestial sphere with respect to the rotation shaft, the hemisphere and disk are rotated together with the celestial sphere, making it difficult to confirm the supernal sphere of the observation point from the viewpoint of the observer standing on the horizon.

### INVENTION

### Technical Problem

The present disclosure is to solve the above problems and to provide a celestial globe for education which has a structure with good learning effect, is inexpensive, is easy to change the latitude of an observation point, keeps a horizon to be horizontal with the ground, and can be stored in a small space by reducing the volume such that individual students can learn.

### Technical Solution

A celestial globe for education according to the present disclosure may comprise a celestial sphere displaying a constellation, a horizontal coordinate system comprising a disk part accommodated inside the celestial sphere and defining the ground of an observation point and an upper hemisphere coupled to an upper side of the disk part and defining the sky viewed from an observer’s point of view, and a rotation shaft member defining a rotation axis of the earth and having one side rotatably coupled to the disk part and the other side passing through the celestial sphere.

In addition, the horizontal coordinate system may further comprise a lower hemisphere coupled to a lower side of the disk part and comprising a guide hole, through which the rotation shaft member passes, and a load part providing a load in a direction of gravity.

In addition, the rotation shaft member may comprise a rotation shaft passing through the celestial sphere and positioned on the guide hole and a rotation center disposed at the center of a circle of the disk part and rotating with respect to the disk part.

In addition, the disk part may comprise a penetration part in which the rotation center is located and a disk coupling part to which the rotation center is rotatably coupled.

In addition, the rotation shaft member may further comprise a stopper formed between the rotation shaft and the rotation center and selectively contacting the disk part and a support coupling part disposed on one side of the rotation shaft and formed smaller than the rotation shaft.

In addition, the stopper may further comprise a disk seating part on which a part of the disk part is seated.

In addition, the disk part may further comprise a rotation shaft seating groove inserted into the disk seating part.

In addition, the disk part may comprise a fitting protrusion for coupling the upper hemisphere and the lower hemisphere, and the upper hemisphere and the lower hemisphere may comprise fitting grooves, into which the fitting protrusion is inserted.

In addition, the rotation shaft member may comprise a first rotation shaft member rotatably coupled to the disk part and a second rotation shaft member detachably coupled to the first rotation shaft member.

In addition, on an outer or inner circumferential surface of the upper hemisphere, a meridian passing through south and north points of a horizon, a zenith and a nadir in the horizontal coordinate system and an azimuth ruler capable of measuring an azimuth on the horizon may be displayed, and a Polaris altitude part according to a latitude of the observation point may be displayed on the meridian.

In addition, the Polaris altitude part may comprise a plurality of through-holes spaced apart at regular intervals along the meridian, and the second rotation shaft member may be coupled to the first rotation shaft member in a state of being inserted into a through-hole corresponding to a latitude of an observer among the plurality of through-holes.

In addition, the first rotation shaft member may comprise a rotation center disposed at the center of a circle of the disk part and movably mounted on the disk part along the meridian with respect to the disk part, a first rotation shaft passing through the celestial south pole and connected to one side of the rotation center, and a rotation shaft coupling part connected to the other side of the rotation center, located on an extension of the first rotation shaft and coupled with the second rotation shaft member.

In addition, the second rotation shaft member may comprise a second rotation shaft passing through the celestial north pole and the Polaris altitude part and coupled to the rotation shaft coupling part.

In addition, the celestial sphere may comprise an upper hemisphere formed in a hemispherical shape and having a celestial north pole formed therein and a lower hemisphere having a shape corresponding to the upper hemisphere, coupled to the upper hemisphere and having formed therein a celestial south pole, through which the rotation shaft member passes, and the upper hemisphere and the lower hemisphere may be detachably coupled.

In addition, the upper hemisphere and the lower hemisphere may further comprise an ecliptic line display part displaying the ecliptic, which is a moving orbit of the sun, and the ecliptic line display part defines one ecliptic forming a closed loop when the upper hemisphere and the lower hemisphere are coupled.

In addition, the upper hemisphere or the lower hemisphere may further comprise a sun display part representing the sun moving along the ecliptic line display part, and the sun display part may be configured to rotate with respect to any one of the upper hemisphere or the lower hemisphere.

In addition, the sun display part may comprise a rotation body located inside any one of the upper hemisphere and the lower hemisphere and comprising a light source representing the sun and a rotation body fixing part coupled to the rotation body outside any one of the upper hemisphere and the lower hemisphere and capable of rotating the rotation body.

A celestial globe assembly according to the present disclosure may comprise a celestial globe and a celestial globe support on which the celestial globe is supported. The celestial globe support may comprise a support plate in which a support insertion part is formed and a support movably coupled to the support plate insertion part.

In addition, the rotation shaft member may be fixed to one side of the support and a part of the celestial sphere is rotatably supported on the other side of the support.

In addition, the support may further comprise a fixing part for fixing the rotation shaft member.

In addition, the support plate may comprise a guide rib protruding from an inside of the support insertion part, and the support may comprise a guide insertion groove into which the guide rib is inserted.

In addition, the support may comprise an altitude display part for displaying an angle of a rotation shaft, and the support may comprise an altitude indicator for indicating the altitude display part.

In addition, the support plate may further comprise a fixing member for fixing the support, the support plate may further comprise one fixing member insertion groove into which one side of the fixing member is inserted, the support may further comprise a plurality of other fixing member insertion grooves, into which the other side of the fixing member is inserted, and spaced part at a certain angle in a circumferential direction within a range of 90 degrees.

In addition, the fixing member may be inserted between any one of the plurality of other fixing member insertion grooves corresponding to a latitude of an observer and the one fixing member insertion groove.

### EFFECT OF THE INVENTION

According to the present disclosure, since a celestial globe operates in a state where the horizon is positioned horizontally with the ground, an observer can easily check the supernal sphere of an observation point to be observed from the observer’s point of view.

Also, since the celestial sphere rotates while the horizon is positioned horizontally with the ground, it is possible to check the changing supernal sphere from the observer’s point of view.

Also, since the horizon can be positioned horizontally with the ground, operational convenience can be improved.

In addition, since the latitude of the observation point can be easily changed, it has the advantage of simplifying the manipulation of the celestial globe.

Also, from the observer’s point of view, the sun’s moving orbit can be directly confirmed.

In addition, the concepts of the horizontal coordinate system and the equatorial coordinate system can be easily understood without auxiliary devices such as disks and rims.

In addition, since the celestial globe is made of a transparent material, the observer can identify the constellation as if observing it in the real celestial sphere.

In addition, since manufacturing is easy and small-sized manufacturing is possible, manufacturing costs can be greatly reduced. Accordingly, classes can be given with one celestial globe per person, which can increase the learning effect.

### DESCRIPTION OF DRAWINGS

FIG. 1 is a perspective view of a celestial globe assembly according to an embodiment of the present disclosure.

FIG. 2 is an exploded view of the celestial globe assembly according to an embodiment of the present disclosure.

FIG. 3 is a perspective view of the upper hemisphere according to an embodiment of the present disclosure.

FIG. 4 is a perspective view of the lower hemisphere according to an embodiment of the present disclosure.

FIG. 5 is a diagram showing a concave part of the lower hemisphere according to an embodiment of the present disclosure.

FIG. 6 is a perspective view of a sun display part according to an embodiment of the present disclosure.

FIG. 7 is a perspective view of a horizontal coordinate system according to an embodiment of the present disclosure.

FIG. 8 is a perspective view of a disk part according to an embodiment of the present disclosure.

FIG. 9 is a perspective view of a rotation shaft member according to an embodiment of the present disclosure.

FIG. 10 is a diagram illustrating a state in which a horizontal coordinate system is coupled to the celestial globe support according to an embodiment of the present disclosure.

FIG. 11 is a cross-sectional view of a celestial globe assembly according to an embodiment of the present disclosure.

FIG. 12 is a perspective view of a celestial globe assembly according to another embodiment of the present disclosure.

FIG. 13 is an exploded view of the celestial globe assembly according to another embodiment of the present disclosure.

FIG. 14 is a perspective view in which the upper hemisphere is removed from the horizontal coordinate system according to another embodiment of the present disclosure.

FIG. 15 is a view showing a concave part of the disk part according to another embodiment of the present disclosure.

FIG. 16 is a perspective view of the lower hemisphere according to another embodiment of the present disclosure.

FIG. 17 is a perspective view of a rotation shaft member according to another embodiment of the present disclosure.

FIG. 18 is an exploded view of a celestial globe support according to another embodiment of the present disclosure.

FIG. 19 is a view showing a state in which a horizontal coordinate system is coupled to a celestial globe support according to another embodiment of the present disclosure.

FIG. 20 is a cross-sectional view of a celestial globe assembly according to another embodiment of the present disclosure.

### BEST MODE

Hereinafter, preferred embodiments will be described in detail with reference to the accompanying drawings so that those skilled in the art can easily practice the present disclosure. However, in describing a preferred embodiment of the present disclosure in detail, if it is determined that a detailed description of a related known function or configuration may unnecessarily obscure the subject matter of the present disclosure, the detailed description will be omitted. In addition, the same or similar reference numerals are used throughout the drawings for parts having similar functions and operations.

The accompanying drawings show exemplary forms of the present disclosure, which are provided only to explain the present disclosure in more detail, and thus the technical scope of the present disclosure is not limited thereto. In addition, for convenience of description, the size and shape of each illustrated constituent member may be exaggerated or reduced.

On the other hand, terms including ordinal numbers such as first or second may be used to describe various components, but the components are not limited by the terms, and the terms may be used to distinguish one component from another component.

When it is said that a component is ‘connected to’ another component, it should be understood that the one component is connected to the other component directly or through any other component in between. In addition, ‘including’ a certain component means that other components may be further included, rather than excluding other components unless otherwise stated.

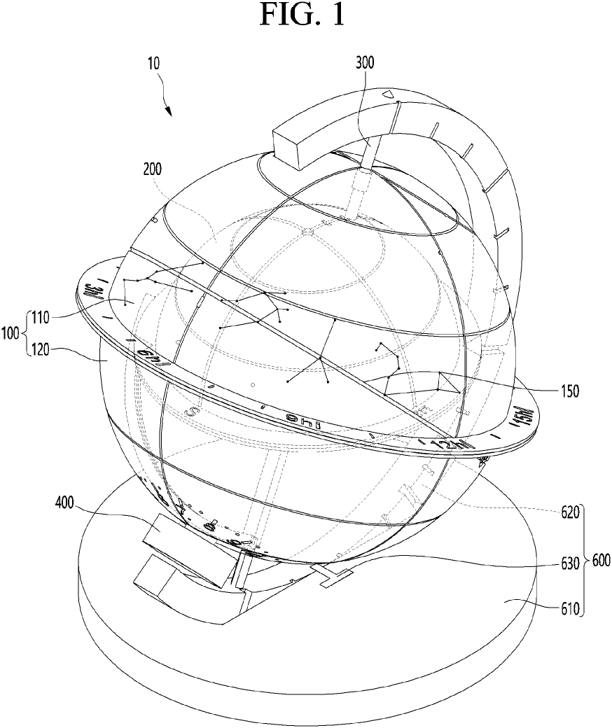

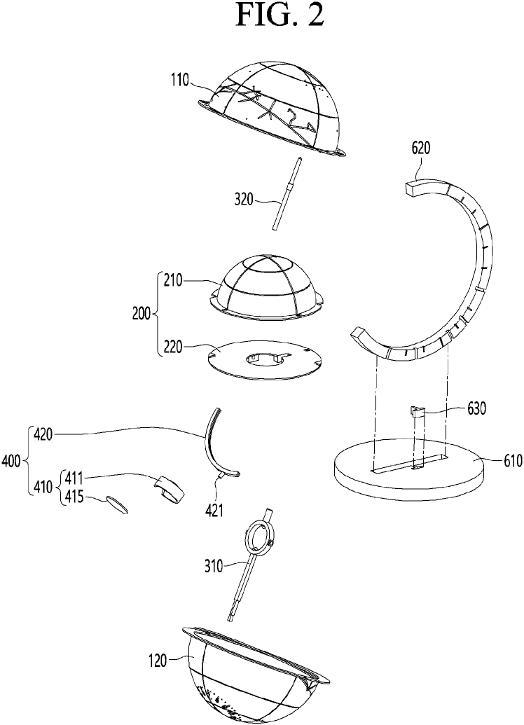

FIG. 1 is a perspective view of a celestial globe assembly according to an embodiment of the present disclosure, and FIG. 2 is an exploded view of the celestial globe assembly according to an embodiment of the present disclosure.

Referring to FIGS. 1 and 2, the celestial globe 10 according to an embodiment of the present disclosure may include a celestial sphere 100 displaying a constellation.

The celestial sphere 100 may include a hemisphere-shaped upper hemisphere 110 and a lower hemisphere 120 having a shape corresponding to the upper hemisphere 110 and coupled to the upper hemisphere 110. The upper hemisphere 110 means the northern hemisphere of the celestial globe, and the lower hemisphere 120 means the lower hemisphere of the celestial globe. The upper hemisphere 110 and the lower hemisphere 120 may be made of a transparent material.

The celestial globe 10 may include a horizontal coordinate system 200 accommodated inside the celestial sphere 100.

The horizontal coordinate system 200 may include a hemisphere part 210 formed in a semicircle shape and a disk part 220 coupled to the hemisphere part 210. The hemisphere part 210 and the disk part 220 may be detachably coupled.

The celestial globe 10 may include a rotation shaft member 300 that passes through the horizontal coordinate system 200 and the celestial sphere 100 to define a rotation axis of the earth.

The rotation shaft member 300 may include a first rotation shaft member 310 and a second rotation shaft member 320 detachably coupled to the first rotation shaft member 310. The first rotation shaft member 310 may be coupled to the disk part 220. The first rotation shaft member 310 may pass through the lower hemisphere 120. The second rotation shaft member 320 may pass through the upper hemisphere 110 and the hemisphere part 210. The first rotation shaft member 310 and the second rotation shaft member 320 may be coupled or separated between the hemisphere part 210 and the disk part 220.

The celestial globe 10 may include a celestial globe support 600 on which the rotation shaft member 300 is supported.

The celestial globe support 600 may support the rotation shaft member 300 to which the celestial sphere 100 and the horizontal coordinate system 200 are coupled. The celestial globe support 600 may be coupled with the celestial sphere 100, the horizontal coordinate system 200, and the rotation shaft member 300 to form a celestial globe assembly.

The celestial globe support 600 may include a support plate 610 and a support 620 supported by the support plate 610.

A support insertion groove into which the support 620 may be inserted is formed in the support plate 610 so that the support 620 may be coupled to the support plate 610. The support plate 610 may have a plate shape placed on the bottom surface. The support 620 is disposed in a direction perpendicular to the support plate 610, and may be rotatably coupled to the support plate 610.

The support 620 may be formed so that the celestial sphere 100 may be located inside. The support 620 may be formed to have a curve having a larger diameter than the diameter of the celestial sphere 100, so that the celestial sphere 100 may be located inside the support 620. In addition, the support 620 is formed in an arc shape extending in a circumferential direction along an outer circumferential surface of the celestial sphere 100, and the celestial sphere 100 may rotate inside the support 620. The rotation shaft member 300 may be detachably coupled to the support 620. Meanwhile, a sun display part 400 to be described later is mounted on the celestial sphere 100, and the celestial sphere 100 on which the sun display part 400 is installed may rotate inside the support 620.

The celestial globe support 600 may include a fixing member 630 for fixing the support 620 to the support plate 610.

One fixing member insertion groove into which a part of the fixing member 630 is inserted may be formed in the support plate 610, and the other fixing member insertion groove into which the remaining part of the fixing member 630 is inserted may be formed in the support 620. When the support 620 and the support plate 610 are coupled, the one fixing member insertion groove and the other fixing member insertion groove are aligned to form one fixing member insertion groove, and the fixing member 630 may be inserted into the fixing member insertion groove. When the fixing member 630 is inserted into the fixing member insertion groove, the support 620 and the support plate 610 may be fixed by the fixing member 630. In this embodiment, the fixing member 630 may be formed in a ‘T’ shape. In addition, although the fixing member insertion groove is described as being formed as an ‘insertion groove’, it is also possible to form an ‘insertion hole’.

Meanwhile, the fixing member 630 may be integrally formed with the support 620 or the support plate 610 so that the support 620 is directly coupled to the support plate 610. When the fixing member 630 protrudes from the support 620, one side of the support insertion groove of the support plate 610 may be depressed to form a fixing member insertion groove. Alternatively, when the fixing member 630 protrudes from the support plate 610, a part of the support 620 may be depressed to form the fixing member insertion groove.

The celestial globe 10 may further include an ecliptic line display part 150 displaying the ecliptic indicating the orbit of the sun.

The ecliptic line display part 150 may be formed as an extension provided to the celestial sphere 100 by printing or the like. The ecliptic line display part 150 may be formed on the upper hemisphere 110 and the lower hemisphere 120. For example, a part of the ecliptic line display part 150 is provided to the upper hemisphere 110, and a remaining portion of the ecliptic line display part 150 is provided to the lower hemisphere 120. Therefore, when the upper hemisphere 110 and the lower hemisphere 120 are coupled, one ecliptic that forms a closed loop may be formed. The ecliptic line display part 150 may be displayed on the inner or outer circumferential surface of the celestial sphere 100 in an engraved or embossed form.

Also, the ecliptic line display part 150 may be detachably provided on the outer circumferential surface of the celestial sphere 100. The ecliptic line display part 150 may serve to display the ecliptic representing the orbit of the sun on the celestial sphere 100 and bind the celestial sphere 100 divided into the upper hemisphere 110 and the lower hemisphere 120. The ecliptic line display part 150 may be made of an elastic member such as a rubber band or a string.

The celestial globe 10 may further include a sun display part 400 displaying movement of the sun on the celestial sphere 100.

The sun display part 400 may be rotatably mounted on the celestial sphere 100. The sun display part 400 may display the sun moving along the ecliptic line display part 150. In this embodiment, the sun display part 400 is rotatably provided to the lower hemisphere 120, and may intuitively display movement of the sun moving along the ecliptic line display part 150.

Hereinafter, each component constituting the celestial globe 10 according to the embodiment of the present disclosure will be described in detail based on the drawings.

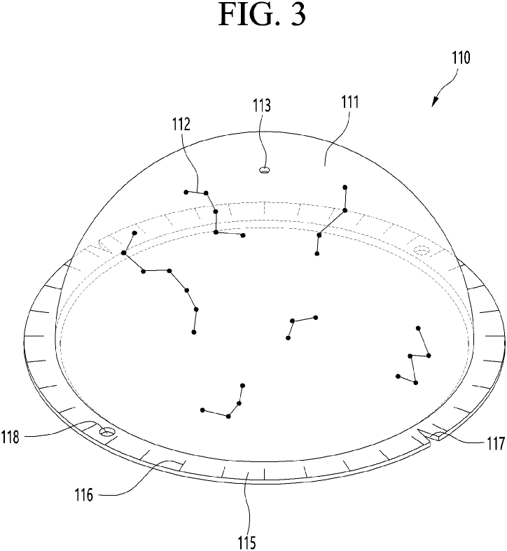

FIG. 3 is a perspective view of the upper hemisphere according to an embodiment of the present disclosure.

Referring to FIG. 3, the upper hemisphere 110 according to an embodiment of the present disclosure includes a spherical part 111 constituting a hemisphere in the upper hemisphere 110, a constellation 112 displayed on an inner or outer circumferential surface of the spherical part 111, a celestial pole 113 through which the rotation shaft member 300 passes, and an upper wing 115 formed at a portion in contact with the lower hemisphere 120.

The spherical part 111 may be made of a transparent material. When the spherical part 111 is made of a transparent material, the horizontal coordinate system 200 located inside the upper hemisphere 110 may be observed from the outside of the upper hemisphere 110.

The constellation 112 may be formed as a hole or a groove. In addition, the constellation 112 printed on the inner or outer circumferential surface of the upper hemisphere 110 may be attached. In addition, a luminous material or a fluorescent material may be applied to the constellation 112 to achieve an aesthetic effect. Since the spherical part 111 is made of a transparent material, it can be seen that the constellation 112 may be observed even when displayed on the inner circumferential surface of the spherical part 111.

On the other hand, when making the celestial globe 10, the lines connecting stars are omitted and only the positions of the stars are displayed, so that a user draws a line connecting the stars with a pen on the spherical part 111 to directly complete the constellation 112. In addition, the user may express a color difference according to the grade of each star constituting the constellation 112 by using a luminous liquid or the like. In this way, the learning effect may be increased through the process of allowing the user to directly complete the constellation 112 during education.

In addition, the constellation 112 may also be displayed on the spherical part 121 of the lower hemisphere 120 to be described later.

The celestial globe north pole 113 defines a celestial globe north pole, which is a part where the extension of the earth’s rotation axis meets the upper hemisphere of the celestial globe, and is formed as a through hole, so that the rotation shaft member 300 may be inserted.

The upper wing 115 may include a right ascension ruler 116 formed at regular intervals on the upper wing 115. The upper wing 115 may further include a pair of detachable grooves 117 in which the ecliptic line display part 150 is installed. The upper wing 115 may further include a pair of hanging holes 118 into which a hanging line that may be fixed to a ceiling by coupling the upper hemisphere 110 and the lower hemisphere 120 is inserted.

The right ascension ruler 116 is displayed for the purpose of checking the right ascension of the constellation or the like displayed on the celestial sphere 100. Right ascension is an angle from a vernal equinox point to a celestial body, and refers to a value obtained by measuring an angle in a counterclockwise direction from a hour circle passing through the vernal equinox point to a hour circle passing through the celestial body in the range of 0° to 360° or 0 o′clock to 24 o′clock.

The right ascension ruler 116 may be attached with a separate detachable ruler, or the gradation may be directly displayed on the upper wing 115. In addition, although not shown in the drawing, the right ascension ruler 116 may also be formed on the lower wing 125 to be described later.

The detachable groove 117 corresponds to an intersection of the ecliptic line display part 150, which means the ecliptic, and the upper wing 115, which means the celestial globe equator, and means a vernal or autumnal equinox point. Specifically, between two intersections of the celestial globe equator and ecliptic, a point where the sun passes from south to north of the equator is called a vernal equinox point, and a point where the sun passes through the equator from north to south is called a autumnal equinox point.

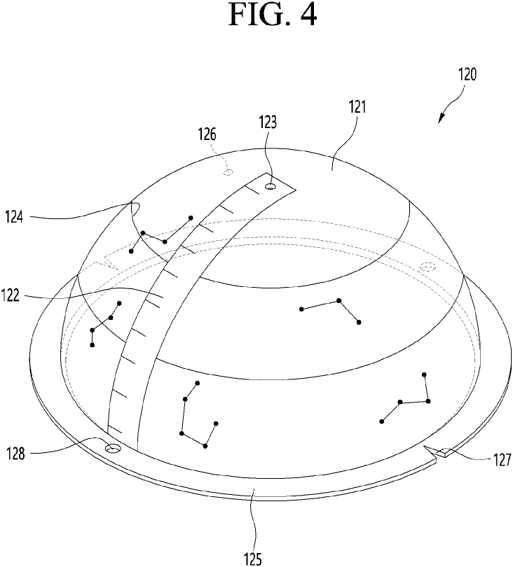

FIG. 4 is a perspective view of the lower hemisphere according to an embodiment of the present disclosure.

Referring to FIG. 4, the lower hemisphere 120 according to an embodiment of the present disclosure includes a spherical part 121 constituting a hemisphere in the lower hemisphere 120, a declination ruler 122 detachably provided on an inner or outer circumferential surface of the spherical part 121, a celestial south pole 123 through which the rotation shaft member 300 passes, an equal declination line 124 composed of a line connecting points having the same declination, and a lower wing 125 formed on a portion in contact with the upper hemisphere 110.

The declination ruler 122 is for measuring the declination of a celestial body. On the other hand, declination is one of the coordinates representing the position of a celestial body on the celestial sphere, and refers to an angle from a celestial globe equatorial plane to the celestial body along the hour circle. At the equator, the northern hemisphere is marked with (+) and the lower hemisphere is marked with (-), representing 0° to ±90°.

In the declination ruler 122, one end of the declination ruler 122 is penetrated by the rotation shaft member 300, and the other end is rotatable in a circumferential direction along the outer circumferential surface of the celestial sphere 100 centered on the rotation shaft member 300. At this time, an adhesive may be applied to the other end of the declination ruler 122 so as to be attached and detached in the vicinity of the lower wing 125.

Also, unlike the above, the declination ruler 122 may be directly displayed on the inner or outer circumferential surface of the spherical part 121 in an engraved or embossed form. In addition, the declination ruler 122 may also be provided to the spherical part 111 of the upper hemisphere 110.

In the equal declination line 124, some declination values of the declination ruler 122 may be displayed at equal intervals. Also, the equal declination line 124 may be formed on an inner circumferential surface or outer circumferential surface of the spherical part 111 of the upper hemisphere 110.

The celestial globe south pole point 123 defines a celestial globe south pole, which is a part where the extension of the earth’s rotation axis contacts the lower hemisphere of the celestial globe, and is formed as a through hole so that the rotation shaft member 300 may be inserted.

A detachable groove 127 and a hanging hole 128 into which a hanging line is inserted may be formed in the lower wing 125. The detachable groove 127 and the hanging hole 128 of the lower wing 125 may be disposed at positions corresponding to the detachable groove 117 and the hanging hole 118 of the upper wing 115.

The upper hemisphere 110 and the lower hemisphere 120 may be detachably coupled. When the upper hemisphere 110 and the lower hemisphere 120 are coupled, the upper wing 115 and the lower wing 125 contact each other, and the upper wing 115 and the lower wing 125 may collectively be referred to as wings 115 and 125. The wings 115 and 125 mean the celestial globe equatorial plane.

A rotation body through-hole 126 in which the sun display part 400 is installed may be formed in the lower hemisphere 120. The rotation body through-hole 126 may be formed at a position where the central axis of rotation of the ecliptic and the lower hemisphere 120 contact each other, based on the central axis of rotation of the ecliptic formed in the celestial sphere 100 by the ecliptic line display part 150. Although, in this embodiment, the rotation body through-hole 126 is described as being formed in the lower hemisphere 120, it may be formed in the upper hemisphere 110. In other words, the rotation body through-hole 126 may be formed in the lower hemisphere 120 or the upper hemisphere 110 crossing a virtual line extending in a vertical direction from the central axis of rotation of the ecliptic. A virtual plane connecting the ecliptic and a virtual line extending in a vertical direction from the rotation body through hole 126 may be perpendicular to each other.

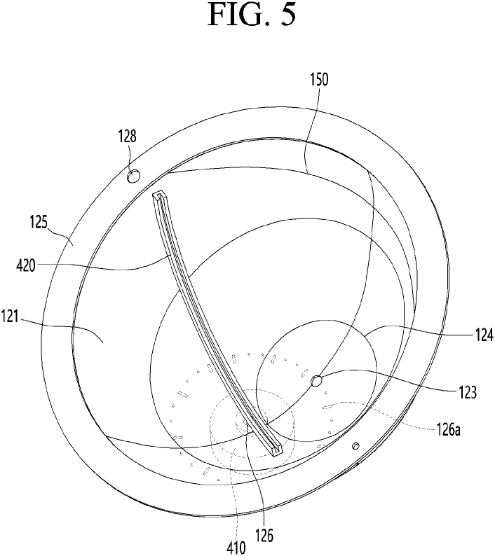

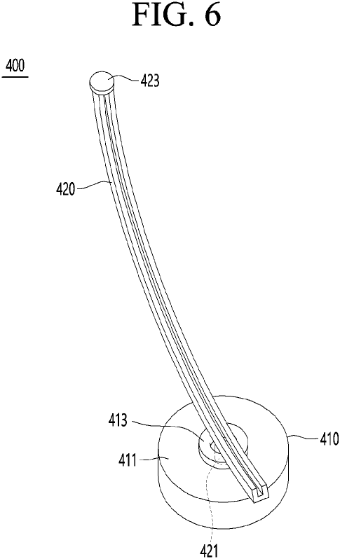

FIG. 5 is a diagram showing a concave part of the lower hemisphere according to an embodiment of the present disclosure, and FIG. 6 is a perspective view of a sun display part according to an embodiment of the present disclosure.

Referring to FIGS. 5 and 6, the sun display part 400 according to the embodiment of the present disclosure may be rotatably mounted on the celestial sphere 100. In this embodiment, the sun display part 400 may be rotatably mounted on the lower hemisphere 120. The sun display part 400 may rotate in a circumferential direction along inner circumferential surfaces of the coupled upper hemisphere 110 and lower hemisphere 120. The sun display part 400 may directly display the sun moving along the ecliptic formed by the ecliptic line display part 150 on the celestial sphere 100. The user may check the movement of the sun in the sky from the observer’s point of view through the sun display part 400.

The sun display part 400 may include a rotation body 420 located inside the celestial sphere 100 and a rotation body fixing part 410 located outside the celestial sphere 100. The rotation body 420 may pass through the rotation body through-hole 126 of the celestial sphere 100 and be coupled to the rotation body fixing part 410.

The rotation body 420 may rotate on the inner circumferential surface of the celestial sphere 100. The rotation body 420 may be formed in a curved or circular arc shape having a smaller diameter than the celestial sphere 100. Also, the rotation body 420 may be formed to be rotatable in a circumferential direction along an inner circumferential surface of the celestial sphere 100. The rotation body 420 may move between the inner circumferential surface of the celestial sphere 100 and the horizontal coordinate system 200.

The rotation body 420 may include a rotation body rotation shaft 421 passing through the celestial sphere 100 and a light source 423 defining the sun. The rotation body rotation shaft 421 is located adjacent to one end of the rotation body 420, and the light source 423 is located adjacent to the other end of the rotation body 420. The rotation body rotation shaft 421 may pass through the celestial sphere 100 and be coupled to the rotation body fixing part 410. A hole through which the rotation body rotation shaft 421 passes may be formed in the celestial sphere 100. When the rotation body 420 rotates with respect to the celestial sphere 100, the light source 423 may move along the ecliptic line display part 150.

The rotation body fixing part 410 may be coupled to the rotation body rotation shaft 421 outside the celestial sphere 100. The rotation body fixing part 410 may include a fixing body 411 having the rotation body rotation shaft 421 coupled thereto and having a space therein, and a body cover 415 coupled to the fixing body 411 to shield the space. A power supply unit supplying power to the light source 423 may be accommodated inside the fixing body 411. The rotation body rotation shaft 421 may be formed to have a hollow so that a wire for supplying power of the power supply unit to the light source 423 passes therethrough.

The rotation body fixing part 410 may include a rotation shaft insertion part 413 into which the rotation body rotation shaft 421 is inserted. The rotation shaft insertion part 413 may be opened so that the rotation body rotation shaft 421 is inserted. The rotation shaft insertion part 413 may communicate with the inner space of the fixing part body 411. The rotation shaft insertion part 413 and the rotation body through-hole 126 may have diameters corresponding to each other. The rotation body rotation shaft 421 may have a diameter smaller than the rotation shaft insertion part 413. That is, when the rotation body 420 and the rotation body fixing part 410 are coupled, the rotation shaft insertion part 413 is positioned in the rotation body through-hole 126, and the sun display part 400 may rotate with respect to the celestial sphere 100.

When the rotation body fixing part 410 to which the rotation body 420 is coupled rotates outside the celestial sphere 100, the rotation body 420 may rotate inside the celestial sphere 100. When the rotation body fixing part 410 rotates clockwise, the rotation body rotates 420 degrees clockwise, and when the rotation body fixing part 410 rotates counterclockwise, the rotation body 420 rotates counterclockwise. Since the rotation body 420 may rotate by manipulating the rotation body fixing part 410, the rotation body fixing part 410 may also be referred to as a rotation body manipulation part for rotating the rotation body 420.

The celestial sphere 100 may further include a date display part 126a. The date display part 126a may display a change in date according to a change in the orbit of the sun. The date display part 126a may be provided in an embossed or engraved shape on an outer or inner circumferential surface of the celestial sphere 100. Also, the date display part 126a may be provided by printing characters on the outer or inner circumferential surface of the celestial sphere 100. In this embodiment, it will be described that the date display part 126a is provided to the lower hemisphere 120 of the celestial sphere 100. The date display part 126a may be formed in a circular shape with the rotation body through-hole 126 as a rotation center. In the date display part 126a, a plurality of gradations indicating a date unit in a clockwise direction may be displayed. When the rotation body fixing part 410 is rotated and the rotation body 420 rotating inside the celestial sphere 100 is placed on the gradation of the date display part 126a displayed in units of dates, the sun display part 400 may be located. For example, the date display part 126a may be provided with a gradation representing a month unit representing January to December and a daily unit. When the user manipulates the rotation body manipulation part of the sun display part 400 in units of months and days to be observed, the sun display part 400 may be located in the orbit of the sun corresponding to units of months and days.

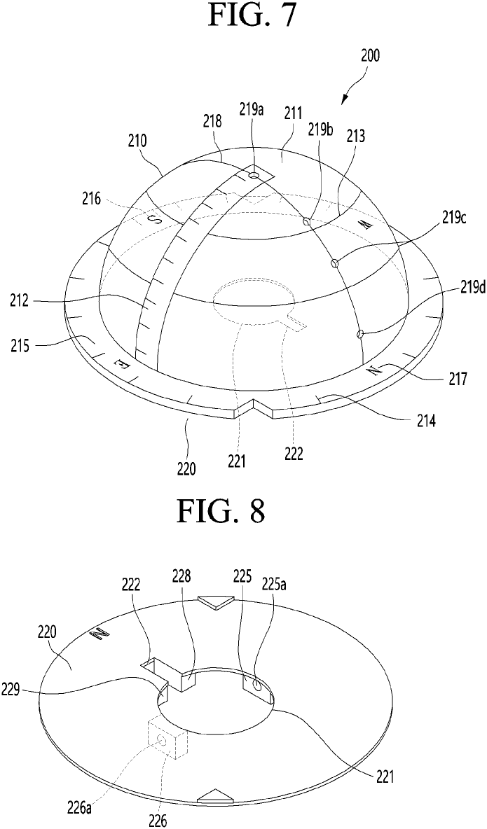

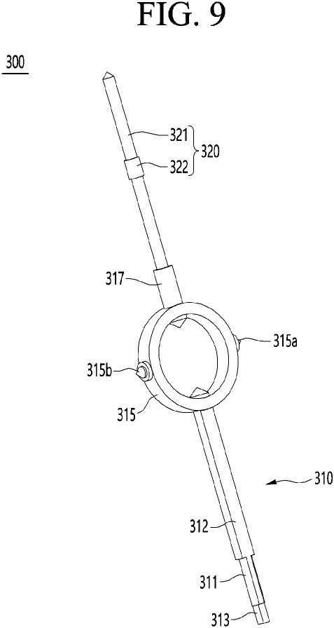

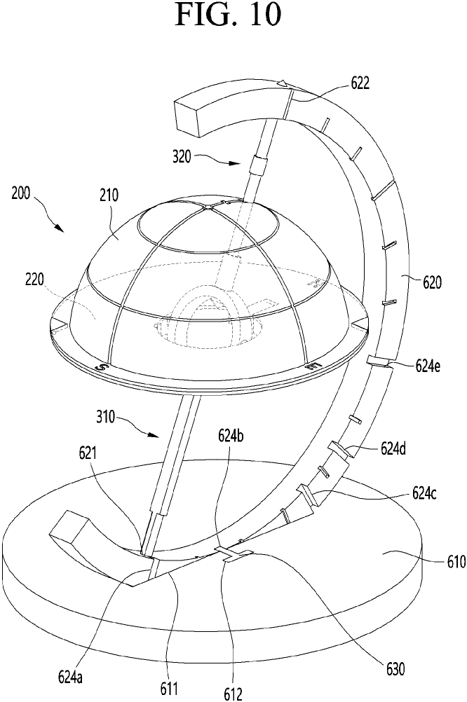

FIG. 7 is a perspective view of a horizontal coordinate system according to an embodiment of the present disclosure, FIG. 8 is a perspective view of a disk part according to an embodiment of the present disclosure, and FIG. 9 is a perspective view of a rotation shaft member according to an embodiment of the present disclosure.

Referring to FIG. 7 of FIGS. 7 to 9, the horizontal coordinate system 200 according to an embodiment of the present disclosure may include the hemisphere part 210 defining the sky from the observer’s point of view, the disk part 220 defining the ground at an observation point and the rotation shaft member 300 positioned at the center of rotation of the disk part 220 and passing through the hemisphere part 210. The hemisphere part 210 may be made of a transparent material, and the disk part 220 may be made of an opaque material.

The disk part 220 has a circular plate shape and may extend in a direction toward the inner circumferential surface of the celestial sphere 100. The observation point is defined at the center of the circle of the disk part 220, and penetration parts 221 and 222 through which the rotation shaft member 300 passes may be formed. The penetration parts 221 and 222 may be formed by opening the center of the disk part 220.

In the constellation 112 of the celestial sphere 100, a celestial body located below and an celestial body located above may be distinguished based on the disk part 220. Since the disk part 220 refers to the observer’s ground, it is possible to check stars located above the ground and stars located below the ground. Based on the disk part 220, a side in contact with the hemisphere part 210 may mean an upper side, and an opposite side may mean a lower side. An upper surface contacting the hemisphere part 210 may be defined as an upper surface of the disk part 220, and a lower surface may be defined as a lower surface of the disk part 220.

The hemisphere part 210 may include a spherical part 211 that forms a spherical surface and means the sky of an observer.

The spherical part 211 may have a zenith point 219a passing through the penetration parts 221 and 222 of the disk part 220 and at which a virtual vertical line meets the hemisphere part 210 at the center of the circle of the disk part 220.

In the spherical part 211, a meridian 218, which is a line passing through the zenith point 219a, a south point 216, and a north point 217, may be displayed. The meridian refers to a line that passes through the south point, north point, zenith, and nadir of the horizon centered on the observer on the celestial sphere.

Polaris altitude parts 219a, 219b, 219c, and 219d indicating the altitude of Polaris according to the observation point may be displayed on the meridian 218. The zenith point 219a may be included in the Polaris altitude parts 219a, 219b, 219c, and 219d.

On the other hand, the altitude of Polaris at the observation point is the same as the latitude at the observation point. Accordingly, the movement of the celestial body may be simulated by changing the through-holes of the Polaris altitude parts 219a, 219b, 219c, and 219d through which the rotation shaft member 300 passes according to the latitude of the observation point.

When the observation point is the North Pole, since the latitude and the altitude of the Polaris are 90 degrees, the rotation shaft member 300 passes through the zenith point 219a having an altitude of 90 degrees. When the observation point is Korea, since the latitude and altitude of Polaris are approximately 37 degrees, the rotation shaft member 300 passes through the third Polaris altitude part 219c having an altitude of 37 degrees. When the observation point is the equator, since the latitude and altitude of Polaris are 0 degrees, the rotation shaft member 300 passes through the fourth Polaris altitude part 219d having an altitude of 0 degrees. The second Polaris altitude part 219b has a latitude and altitude of Polaris of approximately 66 degrees, and defines the Arctic Circle, which is a boundary line dividing a polar region and a temperate region or the winter solstice and summer solstice. When the rotation shaft member 300 passes through the second Polaris altitude part 219b having an altitude of about 66 degrees, a white night phenomenon in which the sun does not set below the horizon on the summer solstice may be confirmed.

The Polaris altitude parts 219a, 219b, 219c, and 219d may further include a plurality of through-holes arranged at regular intervals along the meridian 218, unlike those shown in the drawing. At this time, the number of through-holes may vary according to the set interval.

The hemisphere part 210 may include an altitude ruler 212 detachably provided on an inner circumferential surface or an outer circumferential surface of the spherical part 211.

The altitude ruler 212 is for measuring the altitude of a celestial body when measuring the position of the celestial body on horizontal coordinates. Altitude refers to the shortest angular distance measured along the vertical circle from the horizon to the position of a celestial phenomenon.

The altitude ruler 212 may be directly marked on the inner or outer surface of the spherical part 211 in an engraved or embossed form. The altitude ruler 212 may be provided on the meridian 218 to be described later.

Meanwhile, in the altitude ruler 212, the rotation shaft member 300 passes through one end of the altitude ruler 212, and the other end of the altitude ruler is rotatable in the circumferential direction along the outer circumferential surface of the hemisphere part 210 centered on the rotation shaft member 300. At this time, an adhesive may be applied to the other end of the altitude ruler 212 so as to be attached and detached near a protrusion 215 to be described later.

The hemisphere part 210 may include a contour line 213, which is a line connecting points having the same altitude angle.

The hemisphere part 210 may include a protrusion 215 formed at a portion in contact with the disk part 220. The disk part 220 and the protrusion 215 may contact each other. Also, the protrusion 215 and the disk part 220 may be configured to be coupled to each other.

The protrusion 215 extends in parallel toward the outside of the hemisphere part 210 at a portion where the hemisphere part 210 and the disk part 220 are in contact with each other, and may extend in a direction toward the inner circumferential surface of the celestial sphere 100.

In the protrusion 215, the south point 216 and the north point 217 of the horizontal coordinate system, and an azimuth ruler may be displayed. The south point 216, the north point 217, and the azimuth ruler may be attached in a printed form or may be displayed in an embossed or engraved form.

The azimuth ruler is for measuring the azimuth of the celestial body when measuring the horizontal coordinates of the celestial body. The azimuth refers to an angular distance measured eastward along the horizon from the north point to the point where the vertical circle where the celestial body is located meets the horizon.

Referring to FIG. 8 of FIGS. 7 to 9, the disk part 220 according to the embodiment of the present disclosure may include the penetration parts 221 and 222 penetrating the rotation shaft member 300. The penetration parts 221 and 222 may include the first penetration part 221 formed at the center of the circle of the disk part 220 and the second penetration part 222 formed at one side of the first penetration part 221. The first penetration part 221 and the second penetration part 222 may communicate with each other.

The first penetration part 221 may be located at the center of the circle of the disk part 220, and the rotation shaft member 300 may be located inside the first penetration part 221. The second penetration part 222 may define a space in which a part of the rotation shaft member 300 is accommodated when the rotation shaft member 300 is rotated with respect to the disk part 220. The second penetration part 222 may be formed as an opening extending in a radial direction from the first penetration part 221. The second penetration part 222 may be formed in a size corresponding to a rotation shaft coupling part 317 of the rotation shaft member 300 to be described later.

The disk part 220 may include disk coupling parts 225 and 226 to which the rotation shaft member 300 is coupled. The disk coupling parts 225 and 226 include a first disk coupling part 225 to which one side of the rotation shaft member 300 is coupled and a second disk coupling part 226 to which the other side of the rotation shaft member 300 is coupled. The rotation shaft member 300 may be rotatably coupled to the disk part 220 with the first disk coupling part 225 and the second disk coupling part 226 as rotation centers.

The disk coupling parts 225 and 226 may be formed on the lower surface of the disk part 220. The first disk coupling part 225 may be located on one side of the first penetration part 221, and the second disk coupling part 226 may be located on the other side of the first penetration part 221. The first disk coupling part 225 and the second disk coupling part 226 are disposed to face each other, and may be disposed to face each other with respect to the first penetration part 221. The second penetration part 222 may be formed on a vertical line perpendicularly crossing a virtual straight line connecting the first disk coupling part 225 and the second disk coupling part 226 in the disk part 220.

The first disk coupling part 225 may include a first coupling hole 225a, and the second disk coupling part 226 may include a second coupling hole 226a. The first coupling hole 225a and the second coupling hole 226a may be disposed on a virtual straight line intersecting the center of the circle of the disk part 220. A center line connecting the centers of the first coupling hole 225a and the second coupling hole 226a intersects the center of the circle of the disk part 220, and the rotation shaft member 300 rotates vertically with respect to the center line.

The disk part 220 may further include guide ribs 228 and 229. The guide ribs 228 and 229 may be located on one side and the other side of the second penetration part 222. The guide ribs 228 and 229 may be formed on a lower surface of the disk part 220. The guide ribs 228 and 229 may include a first guide rib 228 located on one side of the second penetration part 222 and a second guide rib 229 located on the other side of the second penetration part 222. The first guide rib 228 and the second guide rib 229 may guide the movement direction of the rotation shaft coupling part 317 when the rotation shaft coupling part 317 of the rotation shaft member 300 moves toward the second penetration part 222. In addition, the first guide rib 228 and the second guide rib 229 are located on both sides of the rotation shaft coupling part 317 movable toward the second penetration part 222, so that an accommodation space in which the rotation shaft coupling part 317 may be accommodated may be formed.

A coupling protrusion for coupling the hemisphere part 210 and the disk part 220 may be formed in the disk part 220. The coupling protrusion may be formed on an upper surface of the disk part 220. A protrusion insertion groove may be formed in the protrusion 215 of the hemisphere part 210 at a position corresponding to the coupling protrusion. The coupling protrusion and the protrusion insertion groove may perform a function of allowing the hemisphere part 210 and the disk part 220 to be coupled at a correct position. In this embodiment, the coupling protrusions are provided as a pair, and a pair of protrusion insertion grooves into which the pair of coupling protrusions are inserted may be formed in the protrusion 215 of the hemisphere part 210.

Referring to FIG. 9 of FIGS. 7 to 9, the rotation shaft member 300 according to an embodiment of the present disclosure may include a first rotation shaft member 310 rotatably mounted to the disk part 220, and a second rotation shaft member 320 detachably coupled to the first rotation shaft member 310. The rotation shaft member 300 may pass through the celestial sphere 100 and the hemisphere part 210 and then be fixed to the celestial globe support 600.

One side of the first rotation shaft member 310 may penetrate the first penetration part 221 of the disk part 220, and the other side of the first rotation shaft member 310 may penetrate the celestial south pole point 123 of the celestial sphere 100 and then be coupled to the celestial globe support 600. One side of the second rotation shaft member 320 may pass through the Polaris altitude parts 219a, 219b, 219c, and 219d of the hemisphere part 210 and then be coupled to the first rotation shaft member 310, and the other side of the second rotation shaft member 320 may pass through the celestial north pole 113 of the celestial sphere 100 and then be coupled to the celestial globe support 600.

The first rotation shaft member 310 may include a first rotation shaft 311 penetrating the celestial south pole 123, a first stopper 312 having a larger diameter than the first rotation shaft 311, and a rotation center 315 rotatably coupled to the disk part 220 and a rotation shaft coupling part 317 to which the second rotation shaft member 320 is coupled.

The first rotation shaft 311 and the first stopper 312 may be connected to one side of the rotation center 315, and the rotation shaft coupling part 317 may be connected to the other side of the rotation center 315. Centers of the first rotation shaft 311, the first stopper 312, the rotation shaft coupling part 317, and the rotation center 315 may be located on the same vertical line.

The rotation shaft coupling part 317 may be connected to one end of the first stopper 312, and the first rotation shaft 311 may be connected to the other end of the first stopper 312. The first stopper 312 may have a larger diameter than the celestial south pole 123 so that the first rotation shaft member 310 is supported by the lower hemisphere 120.

The first rotation shaft 311 penetrates the celestial south pole 123, and may have the same diameter as the celestial south pole 123 or a smaller diameter than the celestial south pole 123. The first rotation shaft 311 may extend from the first stopper 312 in the longitudinal direction. One end of the first rotation shaft 311 may be connected to the first stopper 312, and a support coupling part 313 may be formed at the other end of the first rotation shaft 311.

The support coupling part 313 is a component for fixing the first rotation shaft member 310 to the celestial globe support 600. The celestial globe support 600 may be provided with a first rotation shaft insertion groove 621 into which the support coupling part 313 may be inserted. The first rotation shaft insertion groove 621 and the support coupling part 313 may be formed in a shape corresponding to each other. In order to prevent the first rotation shaft member 310 from rotating with respect to the celestial globe support 600, the support coupling part 313 and the first rotation shaft insertion groove 621 may be formed in a polygonal shape, a semicircle shape, or the like.

The rotation center 315 may include a first coupling protrusion 315a and a second coupling protrusion 315b to be rotatably coupled to the disk part 220. The first coupling protrusion 315a and the second coupling protrusion 315b may extend from the rotation center 315 in a radial direction. The first coupling protrusion 315a may be inserted into the first coupling hole 225a of the disk part 220, and the second coupling protrusion 315b may be inserted into the second coupling hole 226a of the disk part 220. In this embodiment, the rotation center 315 may be formed in a ring shape having a hollow inside. A sphere shaping the earth may be disposed inside the rotation center 315. The rotation center 315 and the first penetration part 221 of the disk part 220 are formed in a shape corresponding to each other, and the rotation center 315 may rotate with the first coupling protrusion 315a and the second coupling protrusion 315b as rotation centers inside the first penetration part 221. In this embodiment, the rotation center 315 may move up and down with respect to the disk part 220 to change the latitude.

One side of the rotation shaft coupling part 317 may be connected to the rotation center 315, and the other side of the rotation shaft coupling part 317 may be formed to have a hollow inside so that the second rotation shaft member 320 is inserted thereinto. The second rotation shaft member 320 may be detachably fitted into the rotation shaft coupling part 317.

The second rotation shaft member 320 may include a second rotation shaft 321 coupled to the rotation shaft coupling part 317 and a second stopper 322 having a larger diameter than the second rotation shaft 321. In this embodiment, the second stopper 322 may be located between one end and the other end of the second rotation shaft 321. At one end of the second stopper 322, a part of the second rotation shaft 321 extends in the longitudinal direction toward the rotation center 315, and at the other end of the second stopper 322, another part of the second rotation shaft 321 extends in the longitudinal direction away from the rotation center 315.

A part of the second rotation shaft 321 may be inserted into the rotation shaft coupling part 317 and pass through the zenith point 219a of the hemisphere part 210. Another part of the second rotation shaft 321 may penetrate the celestial north pole 113 of the upper hemisphere 110. A part of the second rotation shaft 321 may have a diameter corresponding to the zenith point 219a, and another part of the second rotation shaft 321 may have a diameter corresponding to the celestial north pole 113. Another part of the second rotation shaft 321 may pass through the celestial north pole 113 and then be coupled to the celestial globe support 600. The celestial globe support 600 may be provided with a second rotation shaft insertion groove 622 into which another part of the second rotation shaft 321 is inserted.

The second stopper 322 may be located between the celestial sphere 100 and the hemisphere part 210. The second stopper 322 may prevent the second rotation shaft member 320 from moving to the inside of the hemisphere part 210 through the zenith point 219a. In addition, the second stopper 322 may prevent the second rotation shaft member 320 from being separated from the upper hemisphere 110 to the outside by penetrating the celestial north pole 113. In this embodiment, the second stopper 322 may perform a support function of supporting the upper hemisphere 110. In the process of separating the second rotation shaft member 320 from the first rotation shaft member 310, the second rotation shaft member 320 may be separated from the lower hemisphere 120 and the horizontal coordinate system 200 together with the upper hemisphere 110.

After determining the latitude of the observation point that the user wants to observe, the first rotation shaft member 310 may be coupled to the Polaris altitude parts 219a, 219b, 219c and 219d of the hemisphere part 210 corresponding to the latitude of the observation point through the second rotation shaft member 320 on which the upper hemisphere 110 is supported. When the second rotation shaft member 320 is coupled to the first rotation shaft member 310, the upper hemisphere 110 and the lower hemisphere 120 may also be coupled to each other.

FIG. 10 is a diagram illustrating a state in which a horizontal coordinate system is coupled to the celestial globe support according to an embodiment of the present disclosure.

Referring to FIG. 10, the celestial globe 10 according to an embodiment of the present disclosure may be supported by the celestial globe support 600. The celestial globe 10 and the celestial globe support 600 may be collectively referred to as a celestial globe assembly. When the rotation shaft member 300 in which the celestial sphere 100 and the horizontal coordinate system 200 are coupled is fixed to the celestial globe support 600, the user rotates the celestial sphere 100 to observe the diurnal motion of the celestial body at the observation point. FIG. 10 shows a state in which the rotation shaft member 300 to which the horizontal coordinate system 200 is coupled is coupled to the celestial globe support 600.

The celestial globe support 600 may include a support plate 610 and a support 620 coupled to the support plate 610. In this embodiment, the celestial globe support 600 may further include a fixing member 630 for fixing the support 620 coupled to the support plate 610 to the support plate 610.

The support plate 610 is formed in the shape of a plate placed on the floor, and may be formed, for example, as a circular plate. The support plate 610 may include a support insertion groove 611 into which the support 620 is inserted and fixing member insertion grooves 612 and 624 into which the fixing member 630 is inserted.

The support 620 may be formed so that the celestial sphere 100 may be located inside. The support 620 may be formed to have a curve having a larger diameter than the celestial sphere 100, so that the celestial sphere 100 may be located inside the support 620. In addition, the support 620 is formed in an arc shape extending in a circumferential direction along an outer circumferential surface of the celestial sphere 100, and the celestial sphere 100 may rotate inside the support 620.

The support 620 may move with respect to the support insertion groove 611 while being inserted into the support insertion groove 611. In order to fix the support 620 inserted into the support insertion groove 611 to the support plate 610, the fixing member 630 may be inserted into the fixing member insertion grooves 612 and 624.

The fixing member insertion grooves 612 and 624 may include one fixing member insertion groove 612 formed in the support plate 610 and the other fixing member insertion groove 624 formed in the support 620. When the one fixing member insertion groove and the other fixing member insertion groove are aligned, one fixing member insertion groove 612 or 624 may be formed. The fixing member insertion grooves 612 and 624 may be formed to correspond to the fixing member 630.

In this embodiment, a plurality of the other fixing member insertion grooves 624 are provided in the support 620, and the plurality of other fixing member insertion grooves 624a, 624b, 624c, and 624d may be spaced apart from each other. The other fixing member insertion grooves 624a, 624b, 624c, and 624d may be formed by recessing a side surface of the support 620 toward the inside of the support 620. The other fixing member insertion grooves 624a, 624b, 624c, and 624d may be formed to be spaced apart in the support 620 at a predetermined angle in a circumferential direction within a range of 90 degrees. The other fixing member insertion grooves 624a, 624b, 624c, and 624d may be provided at angles corresponding to the Polaris altitude parts 219a, 219b, 219c, and 219d. For example, the first other fixing member insertion groove 624a corresponds to the zenith point 219a, the second other fixing member insertion groove 624b corresponds to the second Polaris altitude part 219b, and the third other fixing member insertion groove 624c may correspond to the third Polaris altitude portion 219c, and the fourth other fixing member insertion groove 624d may correspond to the fourth Polaris altitude portion 219d. Additionally, the fifth other fixing member insertion groove 624e may have a perpendicular angle of 90 degrees with respect to the first other fixing member insertion groove 624a. In the support 620, an angle formed by the second to fifth other fixing member insertion grooves 624b, 624c, 624d, and 624e with respect to the first other fixing member insertion groove 624a is referred to as an ‘insertion groove angle’. The first other fixing member insertion groove 624a may form an angle perpendicular to the ground.

The user may set the angle of the other fixing member insertion groove 624a, 624b, 624c and 624d and the altitude of the Polaris altitude parts 219a, 219b, 219c, and 219d to be the same, and then insert the fixing member 630 into fixing member insertion grooves 612 and 624. The reason for setting the other fixing member insertion grooves 624a, 624b, 624c and 624d and the Polaris altitude parts 219a, 219b, 219c, and 219d equally is that the disk part 220 defining the horizon is placed to be horizontal with the ground.

In the support 620, the first rotation shaft insertion groove 621 into which the first rotation shaft member 310 is inserted may be located at a position where the first other fixing member insertion groove 624a is formed. In the support 620, the second rotation shaft insertion groove 622 into which the second rotation shaft member 320 is inserted may be formed in the support 620 to have an angle of 180 degrees with respect to the first rotation shaft insertion groove 621.

On the other hand, when simulating the movement of the celestial body on the assumption that the user is standing on the disk part 220 of the horizontal coordinate system 200, the user may determine a latitude to be observed, so that the celestial sphere 100 and the horizontal coordinate system 200 may be fixed to the rotation shaft member 300. In addition, it is necessary to fix the celestial globe 10 to the celestial globe support 600 so that the user’s ground and the disk part 220 are horizontal.

The user separates the second rotation shaft member 320 from the first rotation shaft member 310 and make the second rotation shaft member 320 to penetrate any one Polaris altitude part corresponding to the latitude of the observer among the Polaris altitude parts 219a, 219b, 219c, and 219d. The second rotation shaft member 320 penetrating any one Polaris altitude part may be coupled to the first rotation shaft member 310.

The support plate 610 and the support 620 may be fixed so that the support plate 610 and the disk part 220 are horizontal. After coupling the support 620 and the support plate 610 so that the rotation shaft member 300 corresponds to the latitude of the observer, the other fixing member insertion grooves 624a, 624b, 624c and 624d and one fixing member insertion groove 612 may be aligned to couple the fixing member 630.

Since the Polaris altitude parts 219a, 219b, 219c, and 219d into which the rotation shaft member 300 is inserted change according to the latitude of the observation point, the longitudinal direction and angle of the disk part 220 and the rotation shaft member 300 may be changed equal to the altitude of Polaris at the observation point. Specifically, when the altitude of Polaris at the observation point is 90 degrees, the angle between the disk part 220 and the rotation shaft member 300 is also 90 degrees, and when the altitude of Polaris at the observation point is 37 degrees, the angle between the disk part 220 and the rotation shaft member 300 is also 37 degrees. An angle formed between the disk part 220 and the longitudinal direction of the rotation shaft member 300 is referred to as ‘angle of rotation shaft’.

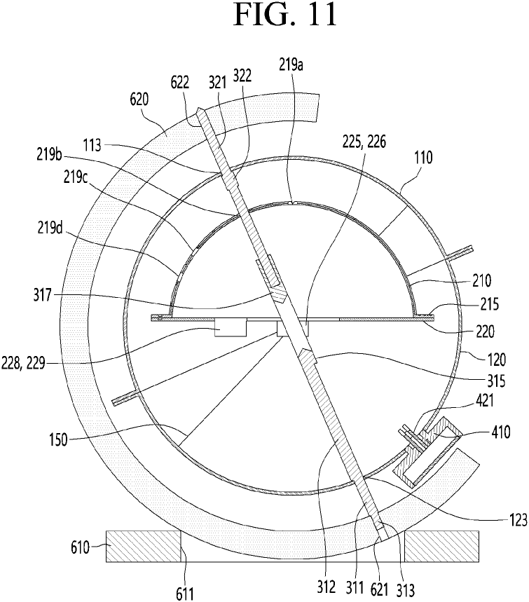

FIG. 11 is a cross-sectional view of a celestial globe assembly according to an embodiment of the present disclosure.

Referring to FIG. 11, the rotation shaft member 300 according to an embodiment of the present disclosure is rotatably fixed to the penetration part 221 of the disk part 220, and may simultaneously penetrate one of the Polaris altitude parts 219a, 219b, 219c, and 219d of the hemisphere part 200, the celestial north pole 113 of the upper hemisphere 110, and the celestial south pole 123 of the lower hemisphere 120.

The point through which the rotation shaft member 300 passes is unchanged in the case of the center of the circle of the penetration part 221, the celestial north pole 113, and the celestial south pole 123, but the only the locations of Polaris altitude parts 219a, 219b, 219c, and 219d are changed according to the latitude of the observation point.

For example, if the latitude of the observation point is 90 degrees, the rotation shaft member 300 is inserted into the zenith point 219a at which the altitude of the Polaris of the Polaris altitude parts 219a, 219b, 219c, and 219d is 90 degrees, and when the latitude of the observation point is 66 degrees, the altitude of Polaris is inserted into the Polaris altitude part 219b corresponding to 66 degrees.

In a state where the rotation shaft member 300 simultaneously penetrates the hemisphere part 210, the disk part 220, the upper hemisphere 110 and the lower hemisphere 120, the celestial Sphere 100 may rotate about the rotation shaft member 300.

Since the rotation shaft member 300 refers to the rotation axis of the earth, when the celestial sphere 100 rotates about the rotation shaft member 300 while the horizontal coordinate system 200 is fixed, diurnal movement of the celestial body at the observation point may be observed.

By allowing the sun display part 400 to rotate along the ecliptic line display part 150 of the celestial sphere 100, the movement orbit of the sun at the observation point may be observed. In addition, the light of the sun irradiated to the horizontal coordinate system 200 and the disk part 220 may be directly checked through the sun display part 400.

According to the present disclosure, the rotation shaft member 300 is configured to be movable in the direction of the meridian 218 from the center of the circle of the disk part 220, so that the rotation shaft member 300 is easily inserted into any one of the Polaris altitude parts 219a, 219b, 219c, and 219d. In addition, since the first rotation shaft member 310 is rotatably provided on the disk part 220, the latitude of the observation point may be changed by separating and coupling the second rotation shaft member 320 from and to the first rotation shaft member 310, thereby improving user’s operational convenience for the celestial globe 10. In addition, since the rotation shaft member 300 to which the disk part 220 is mounted may be firmly fixed to the celestial globe support 600, even when the celestial sphere 100 rotates with respect to the rotation shaft member 300, the disk part 200 defining a horizon may not rotate together with the celestial sphere 100.

On the other hand, although, in this embodiment, the celestial globe support 600 has been described as having the angle of the insertion groove adjusted by the fixing member 630, a rack may be formed on the support 620 and a gear interlocking with the rack and a motor for rotating the gear or a control lever interlocking with the gear are provided on the support plate 610, such that the angle of the insertion groove of the support 620 is easily adjusted with respect to the support plate 610.

According to the present disclosure, since the celestial globe operates in a state where the horizon is positioned horizontally with the ground, the observer may easily check the supernal sphere of the observation point to be observed from the observer’s point of view. In addition, since the celestial sphere rotates while the horizon is positioned horizontally with the ground, it is possible to check the changing supernal sphere from the observer’s point of view. In addition, since the latitude of the observation point may be easily changed, there is an advantage in that manipulation of the celestial globe is simplified. In addition, the concepts of the horizontal coordinate system and the equatorial coordinate system may be easily understood without auxiliary devices such as disks and rims. In addition, since the celestial globe is made of a transparent material, the observer ma check the constellation as if observing it in the actual celestial sphere. In addition, since manufacturing is easy and small-sized manufacturing is possible, manufacturing costs can be greatly reduced. Accordingly, classes can be given with one celestial globe per person, which can increase the learning effect.

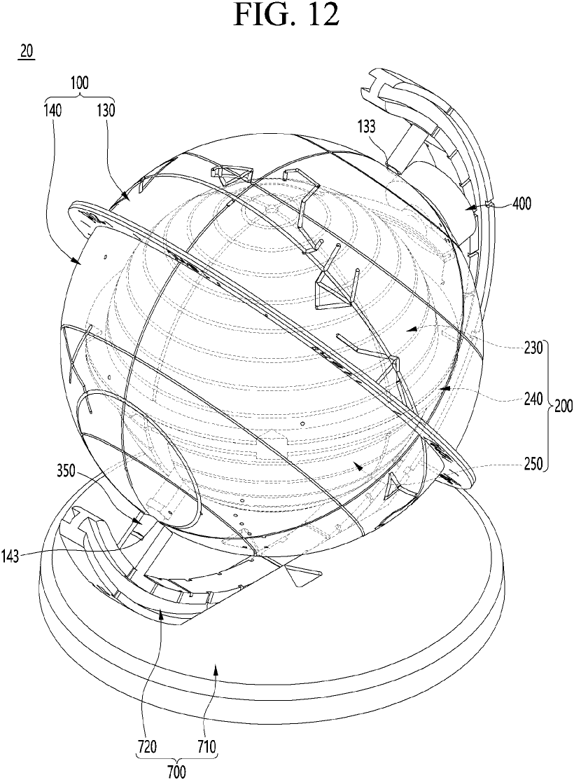

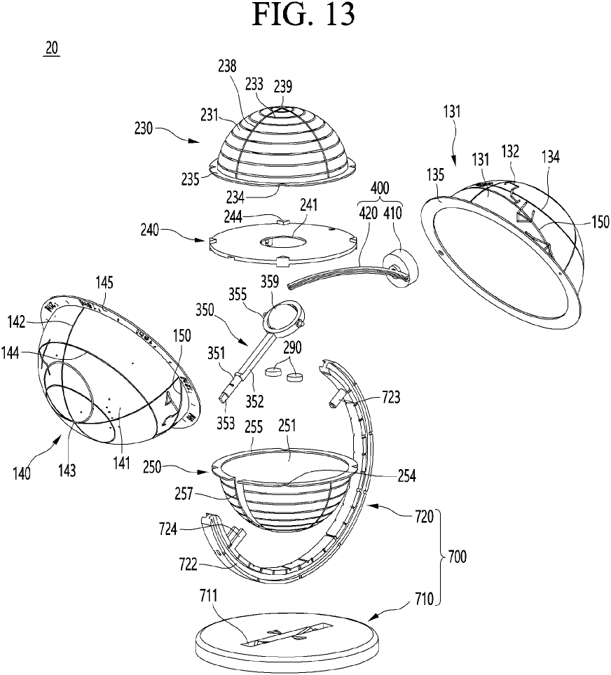

FIG. 12 is a perspective view of a celestial globe assembly according to another embodiment of the present disclosure, and FIG. 13 is an exploded view of the celestial globe assembly according to another embodiment of the present disclosure.

The celestial globe and celestial globe assembly according to another embodiment of the present disclosure are characterized in that some components of the celestial globe and celestial globe assembly according to the above-described embodiment are improved. Thus, some of the components included in the celestial globe and the celestial globe assembly according to another embodiment may be the same as some of the components included in the celestial globe and the celestial globe assembly according to one embodiment. Therefore, a detailed description of some components included in the celestial globe and celestial globe assembly according to another embodiment may be replaced with a description of the same components included in the celestial globe and celestial globe assembly according to one embodiment.

Referring to FIGS. 12 and 13, the celestial globe 20 according to the embodiment of the present disclosure may include the celestial sphere 100 displaying a constellation.

The celestial sphere 100 may include a hemisphere-shaped upper hemisphere 130 and a lower hemisphere 140 having a shape corresponding to the upper hemisphere 130 and coupled to the upper hemisphere 130. The upper hemisphere 130 and the lower hemisphere 140 may be coupled to form the celestial sphere 100 having a spherical shape.

The upper hemisphere 130 may include a spherical part 131 and an upper wing 135. The upper hemisphere 130 may be provided with a constellation 132, an equal declination line 134, a right ascension display part (not shown), and an ecliptic line display part 150. The constellation 132, the equal declination line 134, the right ascension display part (not shown), and the ecliptic line display part 150 may also be provided on the lower hemisphere 140.

The lower hemisphere 140 may include a spherical part 141 and a lower wing 145. The lower hemisphere 140 may be provided with a declination ruler 142 and an equal declination line 144. The declination ruler 142 may also be provided on the upper hemisphere 130.

The upper hemisphere 130 may include a celestial globe north pole 133 formed as a through-hole, and the lower hemisphere 140 may include a celestial globe south pole 143 formed as a through-hole. A rotation body through-hole 136 for mounting the sun display part 400 may be formed in one of the upper hemisphere 130 and the lower hemisphere 140. In this embodiment, the rotation body through-hole 136 may be provided in the upper hemisphere 130. The celestial sphere 100 may rotate about a rotation center line connecting the celestial globe north pole 133 and the celestial globe south pole 143.

The celestial sphere 100 may include a sun display part 400. The sun display part 400 may be rotatably provided to the celestial sphere 100. Although, in this embodiment, the sun display part 400 is described as being provided to the upper hemisphere 130, it may be provided to the lower hemisphere 140.

The sun display part 400 includes a rotation body 420 disposed inside the celestial sphere 100 and displaying the movement path of the sun, and a rotation body fixing part 410 disposed outside the celestial sphere 100. The rotation body 420 and the rotation body fixing part 410 are coupled to each other through the rotation body through-hole 136 and may rotate with respect to the celestial sphere 100. A light source for displaying the sun may be provided to the rotation body 420. The rotation body fixing part 410 may include a power supply unit for supplying power to the light source.

The celestial globe 20 may include the horizontal coordinate system 200 accommodated inside the celestial sphere 100.

The horizontal coordinate system 200 includes an upper hemisphere 230 formed in a semicircle, a lower hemisphere 250 formed in a semicircle, and a disk part 240 to which the upper hemisphere 230 and the lower hemisphere 250 are coupled.

The upper hemisphere 230 and the lower hemisphere 250 may be detachably coupled to the disk part 240. The upper hemisphere 230 may be coupled to the upper side of the disk part 240, and the lower hemisphere 250 may be coupled to the lower side of the disk part 240.

The upper hemisphere 230 may define the sky as seen from the observer’s point of view. The upper hemisphere 230 may include a spherical part 231 and an upper protrusion 235. The upper hemisphere 230 may be provided with an equal altitude line 233, a meridian 238, a zenith point 239, and a Polaris altitude part (not shown). A south point, a north point, and an azimuth ruler of the horizontal coordinate system may be displayed on the upper protrusion 235.

The lower hemisphere 250 may include a spherical part 251 and a lower protrusion 255. The lower hemisphere 250 may include a guide hole 257 through which the rotation shaft member 350 passes, and a load part 290 having a constant weight. The lower hemisphere 250 may also be provided with an equal altitude line. The equal altitude line may be provided to the upper hemisphere. The lower protrusion 255 may be provided with a south point, a north point, and an azimuth ruler of the horizontal coordinate system.

The disk part 240 may define the ground of the observation point. The upper hemisphere 230 may be coupled to the upper side of the disk part 240, and the lower hemisphere 250 may be coupled to the lower side of the disk part 240. The disk part 240 may include a through-hole 241. Inside the through-hole 241, the rotation shaft member 350 may be rotatably positioned.

The upper protrusion 235 and the lower protrusion 255 may be coupled to the disk part 240. A plurality of fitting protrusions 244 spaced apart in a circumferential direction along an outer circumferential surface may be formed in the disk part 240. Fitting grooves 234 and 254 into which the fitting protrusion 244 is inserted may be formed along the outer circumferential surfaces of the upper protrusion 235 and the lower protrusion 255. The fitting protrusion 244 of the disk part 240 is inserted into the fitting grooves 234 and 254 of the upper protrusion 235 and the lower protrusion 255 to fix the coupling position, and the upper protrusion 235 and the lower protrusion 255 may be coupled to the disk part 240 in a state in which the coupling position is fixed.

In this embodiment, the lower hemisphere 250 may be coupled to the lower side of the disk part 240 so that the ground at the observation point is maintained in a horizontal direction. The lower hemisphere 250 may provide a center of gravity in the direction of gravity so that the disk part 240 is maintained in a horizontal orientation.

The celestial globe 20 may include a rotation shaft member 350. The rotation shaft member 350 may be coupled to the disk part 240. The disk part 240 may be rotated by the rotation shaft member 350. The rotation shaft member 350 may pass through the guide hole 257 of the lower hemisphere 250. The rotation shaft member 350 may move along the guide hole 257. The rotation shaft member 350 may pass through the celestial south pole 143 of the lower hemisphere 140. The lower hemisphere 140 may rotate about the rotation shaft member 350 as a rotation center.

The celestial globe 20 may include the rotation shaft member 350 and a celestial globe support 700 supporting the celestial sphere 100. The celestial globe support 700 may be coupled with the celestial sphere 100, the horizontal coordinate system 200, and the rotation shaft member 350 to form a celestial globe assembly.

The celestial globe support 700 may include a support plate 710 and a support 720 supported by the support plate 710. The support 720 may be movably coupled to the support plate 710. The support plate 710 may have a plate shape placed on a bottom surface. The support 720 is disposed in a direction perpendicular to the support plate 710 and may be rotatably coupled to the support plate 710. When the support 720 is rotated with respect to the support plate 710, the altitude of the celestial globe 20 supported on the support 720 may be changed.

Hereinafter, a concave part of the celestial globe 20 according to another embodiment of the present disclosure will be described.

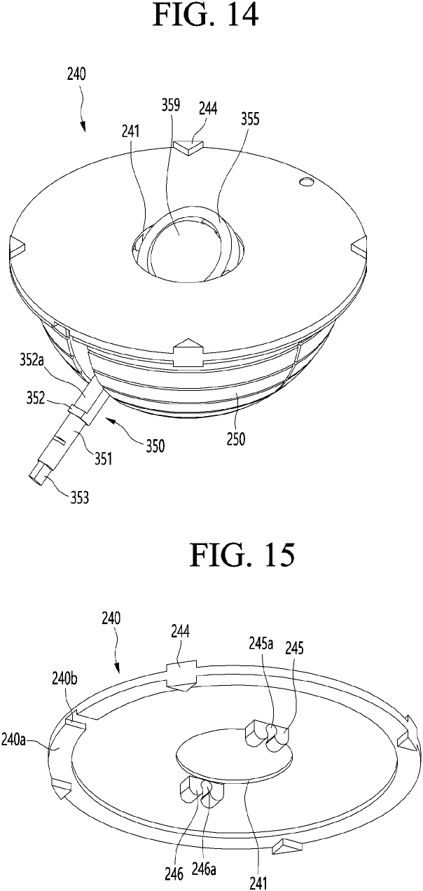

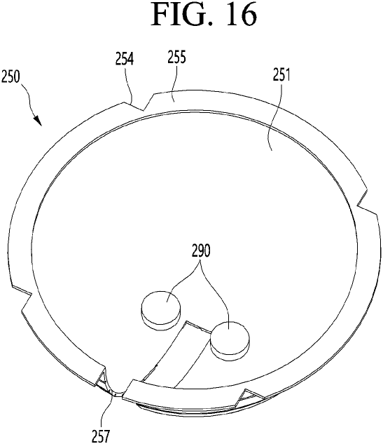

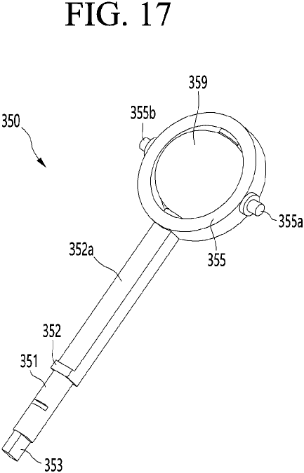

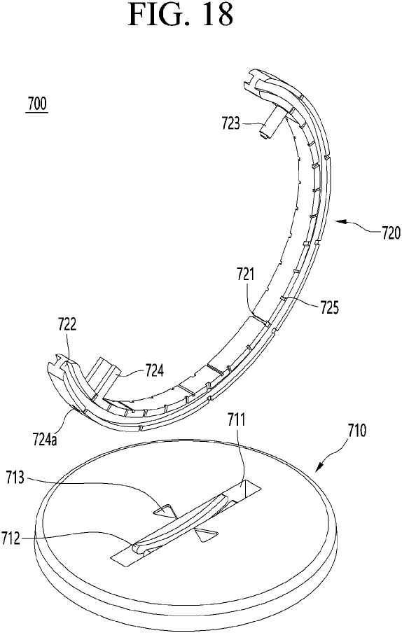

FIG. 14 is a perspective view in which the upper hemisphere is removed from the horizontal coordinate system according to another embodiment of the present disclosure, FIG. 15 is a view showing a concave part of the disk part according to another embodiment of the present disclosure, FIG. 16 is a perspective view of the lower hemisphere according to another embodiment of the present disclosure, and FIG. 17 is a perspective view of a rotation shaft member according to another embodiment of the present disclosure.

Referring to FIGS. 14 to 17, the lower hemisphere 250 and the rotation shaft member 350 may be coupled to the disk part 240 according to the present disclosure. The lower protrusion 255 of the disk part 240 may be fixedly coupled to the lower hemisphere 250. The rotation shaft member 350 may be rotatably coupled to the through-hole 241 of the disk part 240.

The disk part 240 may include a through-hole 241 and a fitting protrusion 244. The through-hole 241 may be formed at the center of the disk part 240. A part of the rotation shaft member 350 may be positioned inside the through-hole 241. A plurality of fitting protrusions 244 may be provided to be spaced apart in the circumferential direction of the disk part 240. The fitting protrusion 244 may protrude from the disk part 240 in a vertical direction. A fitting groove 234 of the upper hemisphere 230 may be inserted into the fitting protrusion 244 protruding to the upper side of the disk part 240. The fitting groove 254 of the lower hemisphere 250 may be inserted into the fitting protrusion 244 protruding to the lower side of the disk part 240.

The disk part 240 may include disc coupling parts 245 and 246. The disk coupling parts 245 and 246 may be provided on the lower surface of the disk part 240. The disk coupling parts 245 and 246 may include a first disk coupling part 245 to which one side of the rotation shaft member 350 is coupled and a second disk coupling part 246 to which the other side of the rotation shaft member 350 is coupled. The first disc coupling part 245 and the second disc coupling part 246 may be disposed to face each other.

The first disk coupling part 245 may include a first coupling hole 245a, and the second disk coupling part 246 may include a second coupling hole 246a. The disk part 240 may rotate with respect to the rotation shaft member 350 with a virtual center line connecting the first coupling hole 245a and the second disk coupling part 246 as a rotation center. The disk part 240 may rotate in a vertical direction with the virtual center line as a rotation center.

The disk part 240 may include a lower extension 240a. The lower extension 240a may extend downward from the lower surface of the disk part 240. The lower extension 240a may be formed to extend in a circumferential direction from an outer circumferential surface of the disk part 240. The lower extension 240a may include a rotation shaft seating groove 240b.

A part of the rotation shaft member 350 may be inserted into the rotation shaft seating groove 240b. The rotation shaft seating groove 240b may be formed by recessing a part of the lower extension 240a upward.

On the other hand, one end and the other end of the lower extension 240a may be connected to the rotation shaft seating groove 240b. One end and the other end of the lower extension 240a may be spaced apart from each other by the rotation shaft seating groove 240b. The rotation shaft seating groove 240b may be formed to have a size allowing the rotation shaft member 350 to be inserted.

The rotation shaft seating groove 240b may allow the rotation shaft member 350 coupled to the disk coupling parts 245 and 246 and the disk part 240 to be positioned horizontally. The rotation shaft member 350 may include a disk seating part 352a for horizontally positioning the disk part 240 and the rotation shaft member 350. When the disk seating part 352a is inserted into the rotation shaft seating groove 240b, the rotation shaft member 350 and the disk part 240 may be positioned horizontally.

The lower hemisphere 250 may include a spherical part 251 and a lower protrusion 255. A guide hole 257 may be formed in the spherical part 251. A fitting groove 254 may be formed in the lower protrusion 255. The fitting grooves 254 corresponding in number to the number of the fitting protrusions 244 may be formed at positions corresponding to those of the fitting protrusions 244 formed on the disk part 240.

The guide hole 257 may guide the movement direction of the rotation shaft member 350. In a state in which the rotation shaft member 350 is supported by the support 720 of the celestial globe support 700, the rotation shaft member 350 may move along the guide hole 257. The guide hole 257 may be formed by opening from a point where a virtual vertical line meets the spherical part 251 at the center of the circle of the disk part 240 to the lower protrusion 255. The rotation shaft member 350 may move through the lower hemisphere 250 by the guide hole 257. The rotation shaft member 350 may move from 0 degrees, which is a horizontal angle with the disk part 240, to 90 degrees, a vertical angle with respect to the disk part 240, by the guide hole 257.

The lower hemisphere 250 may include a load part 290. A plurality of load parts 290 may be provided on both sides of the guide hole 257. The plurality of load parts 290 may be disposed to face each other on both sides of the guide hole 257. The load part 290 may be located on the same straight line extending from a point where a virtual vertical line meets the spherical part 251 at the center of the circle of the disk part 240. A straight line extending from a point where the spherical part 251 meets may be located in a direction perpendicular to a direction in which the guide hole 257 is formed. In this embodiment, since the guide hole 257 is formed at one point of the spherical part 251, it will be described that the plurality of load parts 290 are provided on both sides of the guide hole 257.

By providing a plurality of load parts 290, it is possible to prevent the lower hemisphere 250 from being deflected. Since the load part 290 provides a constant weight in the direction of gravity, one point of the spherical part 251 faces the direction of gravity, so that the disk part 240 coupled to the lower protrusion 255 is horizontal to a direction perpendicular to the direction of gravity.

Meanwhile, although, in this embodiment, the lower hemisphere 250 is described as providing a function for maintaining the disk part 240 in a horizontal direction, the configuration of the lower hemisphere 250 may be provided to the upper hemisphere 230.

The rotation shaft member 350 according to the present disclosure may include a rotation shaft 351, a stopper 352, a support coupling part 353, and a rotation center 355.

The rotation shaft 351 may pass through the celestial sphere 100. Specifically, the rotation shaft 351 may penetrate the celestial globe south pole 143 of the lower hemisphere 140. The lower hemisphere 140 may rotate around the rotation shaft 351 as a rotation center. The stopper 352 and the rotation center 355 may be positioned on one side of the rotation shaft 351, and the support coupling part 353 may be positioned on the other side of the rotation shaft 351.

The stopper 352 may be connected to the rotation shaft 351. The stopper 352 may have a larger diameter than the rotation shaft 351. In this embodiment, the rotation shaft 351 may have a circular cross section, and the stopper 352 may have a polygonal cross section. The rotation shaft 351 passes through the celestial globe south pole 130 of the lower hemisphere 140, and the lower hemisphere 140 may contact the stopper 352 to limit its movement. The celestial globe south pole 143 may have a smaller diameter than the stopper 352 and may have a diameter corresponding to that of the rotation shaft 351.

The stopper 352 may include a disk seating part 352a. The disk seating part 352a may be formed by recessing a part of the stopper 352. The disk seating part 352a may be formed by recessing one side of the stopper 352 facing the lower surface of the disk part 240. The disk seating part 352a is inserted into the rotation shaft seating groove 240b of the disk part 240, and when the disk seating part 352a is inserted into the rotation shaft seating groove 240b, the upper surfaces of the stopper 352 and the disk part 240 may be located in a horizontal direction. In addition, the disk part 240 may be inserted into the disk seating part 352a together with the rotation shaft seating groove 240b. Specifically, the inner circumferential surface of the disk part 240 where the through-hole 241 is formed to the outer circumferential surface of the disk part 240 may be seated in the disk seating part 352a.

The rotation center 355 may be connected to the stopper 352. The rotation center 355 may be rotatably coupled to the disk part 240. The rotation center 355 may include a first rotation shaft 351 and a second rotation shaft 351. The first rotation shaft 355a and the second rotation shaft 355b may be coupled to the disk coupling parts 245 and 246 of the disk part 240. The rotation center 355 may pendulum-move the disk coupling parts 245 and 246 of the disk part 240 as a rotation center. The rotation shaft member 350 may move in a direction toward the disk part 240 with a virtual straight line connecting the first rotation shaft 351 and the second rotation shaft 351 as a rotation center.

The support coupling part 353 may be connected to the rotation shaft 351. The support coupling part 353 may fix the rotation shaft member 350 to the support 720. In this embodiment, the support coupling part 353 may have a polygonal cross section. When the cross section of the support coupling part 353 is formed in a polygonal shape, rotation of the rotation shaft member 350 relative to the support 720 may be restricted. In this embodiment, the support coupling part 353 may have a smaller diameter than the rotation shaft 351.

The rotation shaft member 350 may further include an earth display part 359. The earth display part 359 may be positioned inside the rotation center 355. The earth display part 359 may be positioned inside the through-hole 241 and exposed to the outside. The earth display part 359 may intuitively display the shape of the earth to improve students’ comprehension.

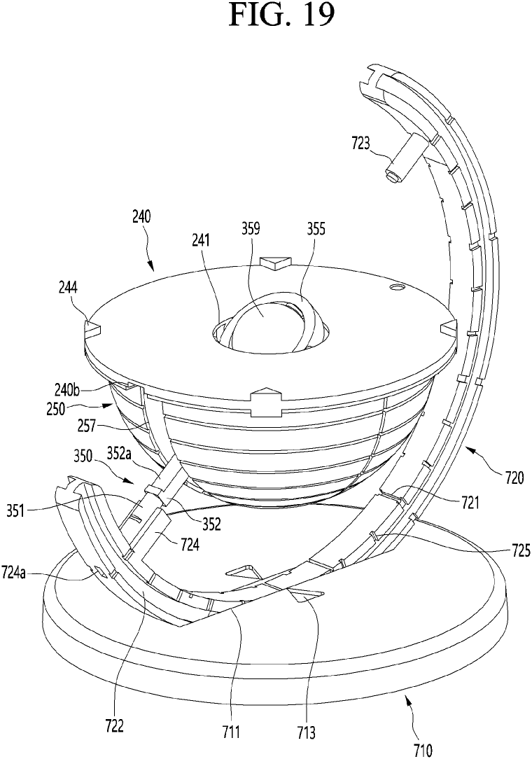

FIG. 18 is an exploded view of a celestial globe support according to another embodiment of the present disclosure.

Referring to FIG. 18, the celestial globe support 700 according to the present disclosure may include a support plate 710 and a support 720. The support 720 may support the celestial sphere 100 and the horizontal coordinate system 200. The celestial sphere 100 may rotate on the support 720 by the rotation shaft member 350. In the horizontal coordinate system 200, the disk part 240 may be maintained in a horizontal direction inside the celestial sphere 100.

The support plate 710 is formed in the shape of a plate placed on the floor, and, for example, may be formed in a circular plate. The support plate 710 may include a support insertion part 711 into which the support 720 is inserted. The support insertion part 711 may be formed by opening the support plate 710. The support insertion 711 may have a size corresponding to that of the support 720.

The support plate 710 may include an altitude indicator 713 for displaying an angle of a rotation shaft. The altitude indicator 713 may be formed in an arrow shape. The altitude indicator 713 may indicate the altitude display parts 721 and 725 displayed on the support 720. When the support 720 rotates with respect to the support plate 710, the altitude indicator 713 may display an angle between the support plate 710 and the rotation shaft member 350 mounted on the support 720. The user may adjust the angle of the rotation shaft of the support 720 based on the altitude indicator 713. The angle of the rotation shaft may define an angle formed between the support plate 710 and the longitudinal direction of the rotation shaft member 350. The angle of the rotation shaft may represent the altitude of Polaris at the observation point. In addition, an angle formed between the longitudinal direction of the rotation shaft member 350 and the support plate 710 may define an observer’s latitude.

The support insertion part 711 may include a guide rib 712. The guide rib 712 may be formed inside the support insertion part 711. The guide rib 712 may protrude inward from an inner surface of the support insertion part 711. The support insertion part 711 may be formed in a circular arc shape or a semicircular shape corresponding to the support 720. The support 720 may move along the support insertion part 711. In this embodiment, a plurality of guide ribs 712 may be formed in a direction inward from inner surfaces of both sides of the support insertion part 711.

The support 720 may be formed in a semicircular shape. The support 720 may have a larger diameter than the celestial sphere 100 . The celestial sphere 100 may rotate inside the support 720. Also, the support 720 may be formed in an arc shape extending in a circumferential direction along an outer circumferential surface of the celestial sphere 100.

The support 720 may include altitude display parts 721 and 725. The altitude display parts 721 and 725 may include a first altitude display part 721 formed on one side of the support 720 and a second altitude display part 725 formed on the other side of the support 720. The altitude display parts 721 and 725 may be marked as gradations on the support 720. The altitude display parts 721 and 725 may be displayed in degrees on the support 720. For example, the altitude display parts 721 and 725 may be marked as gradations in units of 10 degrees.

The first altitude display part 721 may display the preset altitude of the Polaris. The first altitude display part 721 may include Polaris altitude 0 degrees where the observation point is the equator, Polaris altitude 37 degrees where the observation point is Korea, and Polaris altitude 66 degrees where the observation point is the Arctic Circle.

The second altitude display part 725 may display the Polaris altitude from 0 degrees to 90 degrees. The second altitude display part 725 may display the Polaris altitude from 0 degrees to 180 degrees. The altitude display parts 721 and 725 may be spaced apart from each other in the circumferential direction of the support 720.

In this embodiment, the first altitude display part 721 may be formed on the inner surface of the support 720, and the second altitude display part 725 may be formed on the side surface of the support 720. The inner surface of the support 720 defines one surface facing the celestial sphere 100, the outer surface of the support 720 defines the other surface away from the celestial sphere 100, and the side surface of the support 720 may be understood as both surfaces connecting the inner surface and the outer surface.

The support 720 may include a guide insertion groove 722. The guide insertion groove 722 may be formed on the side surface of the support 720. The guide insertion groove 722 may be inserted into the support insertion part 711 of the support plate 710. The guide insertion groove 722 may extend from one end of the support 720 toward the other end. That is, the guide insertion groove 722 may extend in a circumferential direction of the support 720. As the guide insertion groove 722 slides along the support insertion part 711, the support 720 may rotate with respect to the support plate 710.

The support 720 may include one fixing part 723 rotatably fixed to the celestial globe north pole 133 of the upper hemisphere 130 and the other fixing part 724 to which the rotation shaft member 350 is fixed. The rotation shaft member 350 may be rotatably mounted on the celestial globe south pole 143 of the lower hemisphere 140.

The one fixing part 723 may be located adjacent to one end of the support 720, and the other fixing part 724 may be located adjacent to the other end of the support 720. The one fixing part 723 and the other fixing part 724 may be positioned on a virtual line extending in the longitudinal direction of the rotation shaft member 350. That is, the celestial sphere 100 may rotate with a virtual line connecting the one fixing part 723 and the other fixing part 724 as a rotation center.

The other fixing part 724 may be formed so that the rotation shaft member 350 may be seated thereon. The other fixing part 724 may be formed in a shape surrounding a part of the rotation shaft member 350. A coupling groove 724a into which the support coupling part 353 is inserted may be formed in the other fixing part 724. In a state in which the rotation shaft member 350 is seated on the other fixing part 724, the support coupling part 353 may be inserted and fixed into the coupling groove 724a. In this embodiment, the rotation shaft member 350 may support the horizontal coordinate system 200. Therefore, the load of the horizontal coordinate system 200 is concentrated on the rotation shaft member 350, and the load applied to the rotation shaft member 350 is distributed through the other fixing part 724 to the support 720, thereby ensuring durability.

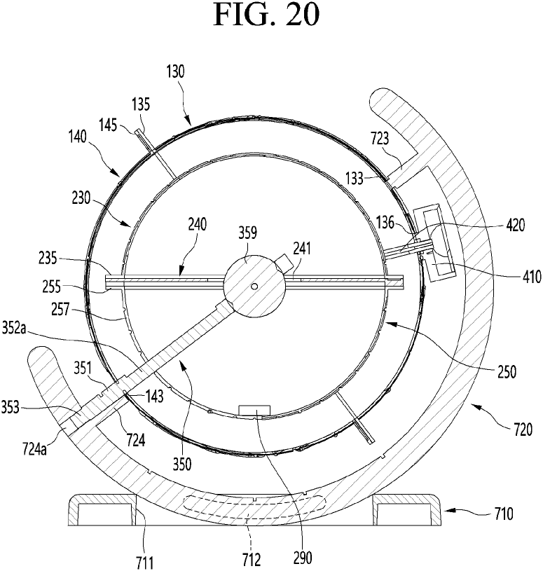

FIG. 19 is a view showing a state in which a horizontal coordinate system is coupled to a celestial globe support according to another embodiment of the present disclosure, and FIG. 20 is a cross-sectional view of a celestial globe assembly according to another embodiment of the present disclosure.

Referring to FIGS. 19 and 20, the horizontal coordinate system 200 may be disposed inside the celestial sphere 100 according to the present disclosure. The horizontal coordinate system 200 may be rotatably supported by the rotation shaft member 350. The rotation shaft member 350 may pass through the lower hemisphere 140 of the celestial sphere 100 and be fixed to the other fixing part 724 of the support 720. The upper hemisphere 130 of the celestial sphere 100 may be rotatably fixed to one fixing part 723 of the support 720. Since the one fixing part 723 and the other fixing part 724 are positioned on the same virtual line, the celestial sphere 100 may rotate with the virtual line as a rotation center.

The horizontal coordinate system 200 located inside the celestial sphere 100 includes the upper hemisphere 230, the lower hemisphere 250 and the disk part 240 located between the upper hemisphere 230 and the lower hemisphere 250. The rotation shaft member 350 may be rotatably connected to the disk part 240. The lower hemisphere 250 may include a guide hole 257 through which the rotation shaft member 350 passes, and a load part 290 providing a load in a direction of gravity.

That is, by the lower hemisphere 250 coupled to the lower side of the disk part 240, the disk part 240 may be maintained in a horizontal direction while being connected to the rotation shaft member 350. Even when the rotation shaft member 350 moves on the guide hole 257, the disk part 240 may be maintained in a horizontal direction perpendicular to the direction of gravity by the load part 290 of the lower hemisphere 250.

The support 720 to which the rotation shaft member 350 is fixed may be movably mounted with respect to the support plate 710. The support plate 710 may include a support insertion part 711 and a guide rib 712 for movably mounting the support 720 thereon.

Through the altitude display parts 721 and 725 provided on the support 720 and the altitude indicator 713 provided on the support plate 710, the latitude of the observation point and the altitude of Polaris may be adjusted. The latitude of the observation point and the altitude of the Polaris are the same. The support 720 may be moved relative to the support plate 710 so that the altitude indicator 713 of the support plate 710 indicates the altitude display parts 721 and 725 of the support 720 corresponding to the latitude of the observation point.

The angle of the rotation shaft of the rotation shaft member 350 fixed to the support 720 is changed by the movement of the support 720, but the disk part 240 of the horizontal coordinate system 200 may be maintained in a horizontal direction.

According to the present disclosure, even if the latitude of the observation point is changed, the horizon where the observer is located is maintained to be horizontal with the ground, thereby more conveniently use the celestial globe 20.

Although a preferred embodiment of the present disclosure has been focused upon in the above, but this is only an example and does not limit the present disclosure, and those skilled in the art to which the present disclosure belongs will know that various modifications and applications not exemplified above are possible within a range that does not deviate from the essential characteristics of the present disclosure. For example, each component specifically shown in the embodiment of the present disclosure can be modified and implemented. In addition, differences related to these modifications and applications should be construed as being included in the scope of the present disclosure defined in the appended claims.

1. A celestial globe comprising:
a celestial sphere displaying a constellation;
a horizontal coordinate system comprising a disk part accommodated inside the celestial sphere and defining the ground of an observation point and an upper hemisphere coupled to an upper side of the disk part and defining the sky viewed from an observer’s point of view; and
a rotation shaft member defining a rotation axis of the earth and having one side rotatably coupled to the disk part and the other side passing through the celestial sphere.

2. The celestial globe of claim 1, wherein the horizontal coordinate system further comprises a lower hemisphere coupled to a lower side of the disk part and comprising a guide hole, through which the rotation shaft member passes, and a load part providing a load in a direction of gravity.

3. The celestial globe of claim 2, wherein the rotation shaft member comprises:
a rotation shaft passing through the celestial sphere and disposed on the guide hole; and
a rotation center disposed at the center of a circle of the disk part and rotating with respect to the disk part.

4. The celestial globe of claim 3, wherein the disk part comprises:
a penetration part in which the rotation center is disposed inside; and
a disk coupling part to which the rotation center is rotatably coupled.

5. The celestial globe of claim 3, wherein the rotation shaft member further comprises:
a stopper formed between the rotation shaft and the rotation center and selectively contacting the disk part; and
a support coupling part disposed on one side of the rotation shaft and formed smaller than the rotation shaft.

6. The celestial globe of claim 5,
wherein the stopper further comprises a disk seating part on which a part of the disk part is seated, and
wherein the disk part further comprises a rotation shaft seating groove inserted into the disk seating part.

7. The celestial globe of claim 4,
wherein the disk part comprises a fitting protrusion for coupling the upper hemisphere and the lower hemisphere, and
wherein the upper hemisphere and the lower hemisphere comprise fitting grooves, into which the fitting protrusion is inserted.

8. The celestial globe of claim 1, wherein the rotation shaft member comprises:
a first rotation shaft member rotatably coupled to the disk part; and
a second rotation shaft member detachably coupled to the first rotation shaft member.

9. The celestial globe of claim 8,
wherein, on an outer or inner circumferential surface of the upper hemisphere, a meridian passing through south and north points of a horizon, a zenith and a nadir in the horizontal coordinate system and an azimuth ruler capable of measuring an azimuth on the horizon are displayed, and
wherein a Polaris altitude part according to a latitude of the observation point is displayed on the meridian.

10. The celestial globe of claim 9,
wherein the Polaris altitude part comprises a plurality of through-holes spaced apart at regular intervals along the meridian, and
wherein the second rotation shaft member is coupled to the first rotation shaft member in a state of being inserted into a through-hole corresponding to a latitude of an observer among the plurality of through-holes.

11. The celestial globe of claim 9, wherein the first rotation shaft member comprises:
a rotation center disposed at the center of a circle of the disk part and movably mounted on the disk part along the meridian with respect to the disk part;
a first rotation shaft passing through the celestial south pole and connected to one side of the rotation center; and
a rotation shaft coupling part connected to the other side of the rotation center, disposed on an extension of the first rotation shaft and coupled with the second rotation shaft member.

12. The celestial globe of claim 11, wherein the second rotation shaft member comprises a second rotation shaft passing through the celestial north pole and the Polaris altitude part and coupled to the rotation shaft coupling part.

13. The celestial globe of claim 1,
wherein the celestial sphere comprises:
an upper hemisphere formed in a hemispherical shape and having a celestial north pole formed therein; and
and a lower hemisphere having a shape corresponding to the upper hemisphere, coupled to the upper hemisphere and having formed therein a celestial south pole, through which the rotation shaft member passes, and
wherein the upper hemisphere and the lower hemisphere are detachably coupled.

14. The celestial globe of claim 13,
wherein the upper hemisphere and the lower hemisphere further comprise an ecliptic line display part displaying the ecliptic, which is a moving orbit of the sun, and
wherein the ecliptic line display part defines one ecliptic forming a closed loop when the upper hemisphere and the lower hemisphere are coupled.

15. The celestial globe of claim 14,
wherein the upper hemisphere or the lower hemisphere further comprises a sun display part representing the sun moving along the ecliptic line display part,
wherein the sun display part is configured to rotate with respect to any one of the upper hemisphere or the lower hemisphere, and
wherein the sun display part comprises:
a rotation body disposed inside any one of the upper hemisphere and the lower hemisphere and comprising a light source representing the sun; and
a rotation body fixing part coupled to the rotation body outside any one of the upper hemisphere and the lower hemisphere and capable of rotating the rotation body.

16. A celestial globe assembly comprising:
a celestial globe comprising a celestial sphere displaying a constellation, a horizontal coordinate system accommodated inside the celestial sphere and defining the ground of an observation point and the sky viewed from an observer’s point of view, and a rotation shaft member defining a rotation axis of the earth and having one side rotatably coupled to the disk part and the other side passing through the celestial sphere; and
a celestial globe support on which the celestial globe is supported,
wherein the celestial globe support comprises:
a support plate in which a support insertion part is formed; and
a support movably coupled to the support plate insertion part.

17. The celestial globe assembly of claim 16,
wherein the rotation shaft member is fixed to one side of the support and a part of the celestial sphere is rotatably supported on the other side of the support, and
wherein the support further comprises a fixing part for fixing the rotation shaft member.

18. The celestial globe assembly of claim 16,
wherein the support plate comprises a guide rib protruding from an inside of the support insertion part, and
wherein the support comprises a guide insertion groove into which the guide rib is inserted.

19. The celestial globe assembly of claim 18,
wherein the support comprises an altitude display part for displaying an angle of a rotation shaft, and
wherein the support comprises an altitude indicator for indicating the altitude display part.

20. The celestial globe assembly of claim 16,
wherein the support plate further comprises a fixing member for fixing the support,
wherein the support plate further comprises one fixing member insertion groove into which one side of the fixing member is inserted,
wherein the support further comprises a plurality of other fixing member insertion grooves, into which the other side of the fixing member is inserted, and spaced part at a certain angle in a circumferential direction within a range of 90 degrees, and
wherein the fixing member is inserted between any one of the plurality of other fixing member insertion grooves corresponding to a latitude of an observer and the one fixing member insertion groove.
